(19) United States
(12) Patent Application Publication
(10) Pub. No.: US 2006/0128930 A1
(43) Pub. Date: Jun. 15, 2006

(54) Synthesis of sterically hindered phenol based macromolecular antioxidants

(76) Inventors: Ashish Dhawan, Lowell, MA (US); Ashok L. Cholli, Chelmsford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/293,050

(22) Filed: Dec. 2, 2005

Related U.S. Application Data
(60) Provisional application No. 60/633,197, filed on Dec. 3, 2004.

(51) Int. Cl. C08G 61/02; C08G 65/40

(52) U.S. Cl. 528/86; 528/211

(57) ABSTRACT

Disclosed is a method for the synthesis of sterically hindered polymeric antioxidants based on phenol type antioxidant monomers. The method includes polymerizing and alkylating a phenol containing monomer represented by the following structural formula: 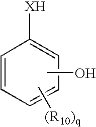
to produce a sterically hindered polymeric macromolecular antioxidant. X, R₁₀ and q are as defined herein. The disclosed method is a simple, direct and economical process for the synthesis of sterically hindered polymeric macromolecular antioxidants.

### RELATED APPLICATION(S)

This application claims the benefit of U.S. Provisional Application No. 60/633,197, filed on Dec. 3, 2004. The entire teachings of the above application(s) are incorporated herein by reference.

### BACKGROUND OF THE INVENTION

Many polymeric antioxidants possess significantly higher antioxidant activities compared to corresponding small molecule antioxidants, along with improved thermal stability and performance in a wide range of materials, for example, plastics, elastomers, lubricants, petroleum based products (lubricants, gasoline, aviation fuels, and engine oils), cooking oil, cosmetics, processed food products, and the like.

The synthesis of polymeric phenol antioxidants (including sterically hindered polymeric phenol antioxidants) from substituted phenols, using a hydroxyl group protection/deprotection approach is described in patent applications to Cholli, et al., including U.S. Provisional Application No. 60/370,468, U.S. Patent Application Publication No.: 2003/230743, International Patent Publication No.s: WO 2003/87260, and WO 2005/071005, and U.S. patent application Ser. No. 10/408,679 the entire teachings of each of which are incorporated herein by reference. These methods require multiple steps and purification of intermediates at each step. For example, WO 2003/87260 discloses a synthesis of poly (tert-butylhydroquinone) (poly(TBHQ)) that requires four separate steps, including separation of intermediate components at each step.

### SUMMARY OF THE INVENTION

Disclosed is a method for the synthesis of sterically hindered polymeric antioxidants based on phenol type antioxidant monomers.

The methods of the present invention include a first step of polymerizing a phenol containing monomer represented by the following structural formula: 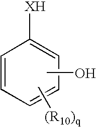
At least one ring carbon atom substituted with an —OH group is adjacent to one unsubstituted ring carbon atom. X is —O—, —NH— or —S—. Each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂ or two R₁₀ groups on adjacent carbon atoms join together to form an optionally substituted aromatic ring or an optionally substituted carbocyclic or heterocyclic non-aromatic ring. q is an integer from 0 to 2.

The resulting polymeric macromolecule comprises at least one repeat unit selected from:

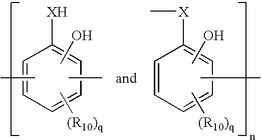

n is an integer equal to or greater than 2.

The variables X, R₁₀ and q are as defined above.

The methods of the present invention further include a second step of alkylating the polymeric macromolecule at a ring carbon atom adjacent (ortho) to a ring carbon atom substituted with an —OH group. This produces a sterically hindered polymeric macromolecular antioxidant comprising at least one repeat unit selected from: 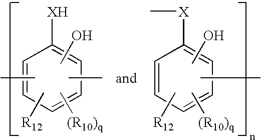
R₁₂ is a bulky alkyl group substituent bonded to a ring carbon atom adjacent (ortho) to a ring carbon atom substituted with an —OH group.

The present invention describes a simple, direct and economical process for the synthesis of polyalkylphenols as antioxidants. The methods of the invention allow for the cost effective synthesis of polymeric antioxidants. Polymeric antioxidants made by the methods of the present invention in general possess significantly higher antioxidant activities along with improved thermal stability and performance in a wide range of materials including but not limited to plastics, elastomers, lubricants, petroleum based products (lubricants, gasoline, aviation fuels, and engine oils), cooking oil, cosmetics, processed food products.

### DETAILED DESCRIPTION OF THE INVENTION

A description of preferred embodiments of the invention follows.

The present invention is generally directed to methods of synthesizing sterically hindered phenol derived antioxidant polymers (polyalkylphenol antioxidants).

Sterically hindered, as used herein means that the substituent group (e.g., bulky alkyl group) on a ring carbon atom adjacent (orpara) to a ring carbon atom substituted with a phenolic hydroxy group (or thiol or amine group), is large enough to sterically hinder the phenolic hydroxy group (or thiol or amine groups). This steric hinderance, in certain embodiments results in more labile or weak bonding between the oxygen and the hydrogen (or sulfur or nitrogen and hydrogen) and in turn enhances the stability and antioxidant activity (proton donating activity) of the sterically hindered antioxidant.

Such antioxidant polymers can be employed to inhibit the oxidation of an oxidizable material, for example by contacting the material with an antioxidant polymer made by the methods of the present invention.

For purposes of the present invention, a method of “inhibiting oxidation” is a method that inhibits the propagation of a free radical-mediated process. Free radicals can be generated by heat, light, ionizing radiation, metal ions and some proteins and enzymes. Inhibiting oxidation also includes inhibiting reactions caused by the presence of oxygen, ozone or another compound capable of generating these gases or reactive equivalents of these gases.

As used herein the term “oxidizable material” is any material which is subject to oxidation by free-radicals or oxidative reaction caused by the presence of oxygen, ozone or another compound capable of generating these gases or reactive equivalents thereof. In particular the oxidizable material is a lubricant or a mixture of lubricants.

Repeat units of the antioxidant polymers of the invention include substituted benzene molecules. These benzene molecules are typically based on phenol or a phenol derivative, such that they have at least one hydroxyl or ether functional group. In certain embodiments, the benzene molecules have a hydroxyl group. The hydroxyl group can be a free hydroxyl group and can be protected or have a cleavable group attached to it (e.g., an ester group). Such cleavable groups can be released under certain conditions (e.g., changes in pH), with a desired shelf life or with a time-controlled release (e.g., measured by the half-life), which allows one to control where and/or when an antioxidant polymer can exert its antioxidant effect. The repeat units can also include analogous thiophenol and aniline derivatives, e.g., where the phenol —OH can be replaced by —SH, —NH—, and the like.

Substituted benzene repeat units of an antioxidant polymer of the invention are also typically substituted with a bulky alkyl group or an n-alkoxycarbonyl group. In certain embodiments, the benzene monomers are substituted with a bulky alkyl group. In certain other embodiments, the bulky alkyl group is located ortho or meta to a hydroxyl group on the benzene ring, typically ortho. A “bulky alkyl group” is defined herein as an alkyl group that is branched alpha- or beta- to the benzene ring. In certain other embodiments, the alkyl group is branched alpha to the benzene ring. In certain other embodiments, the alkyl group is branched twice alpha to the benzene ring, such as in a tert-butyl group. Other examples of bulky alkyl groups include isopropyl, 2-butyl, 3-pentyl, 1,1-dimethylpropyl, 1-ethyl-1-methylpropyl and 1,1-diethylpropyl. In certain other embodiments, the bulky alkyl groups are unsubstituted, but they can be substituted with a functional group that does not interfere with the antioxidant activity of the molecule or the polymer. Straight chained alkoxycarbonyl groups include methoxycarbonyl, ethoxycarbonyl, n-propoxycarbonyl, n-butoxycarbonyl and n-pentoxycarbonyl. N-propoxycarbonyl is a preferred group. Similar to the bulky alkyl groups, n-alkoxycarbonyl groups are optionally substituted with a functional group that does not interfere with the antioxidant activity of the molecule or the polymer.

In certain embodiments, the methods of the present invention include the first step of polymerization of a phenol containing monomer, in the presence of an oxidative polymerization catalyst and an oxidant, wherein the phenol containing monomer is represented by the following structural formula: 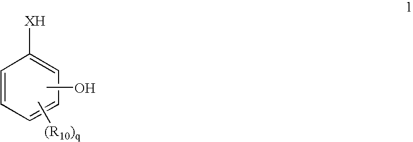
wherein at least one ring carbon atom substituted with an —OH (or —NH₂ or —SH) group (e.g., >C—OH) is adjacent (or ortho) to one unsubstituted ring carbon atom (>C—H). In certain embodiments at least one ring carbon atom substituted with an —OH (or —NH₂ or —SH) group (e.g, >C—OH) is meta orpara to one unsubstituted ring carbon atom (>C—H). X is —O—, —NH— or —S—. In certain embodiments X is —O—. Each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂ or two R₁₀ groups on adjacent carbon atoms join together to form an optionally substituted aromatic ring or an optionally substituted carbocyclic or heterocyclic non-aromatic ring. Additionally, when two R₁₀ groups on adjacent carbon atoms join together to form an optionally substituted aromatic ring or an optionally substituted carbocyclic or heterocyclic non-aromatic ring, the optionally substituted aromatic ring or an optionally substituted carbocyclic or heterocyclic non-aromatic ring may be further fused to another (i.e., a third) optionally substituted aromatic ring or an optionally substituted carbocyclic or heterocyclic non-aromatic ring. q is an integer from 0 to 2.

In certain embodiments, in structural formula 1, each R₁₀ is independently C1-C10 alkyl group, —OH, —SH or —NH₂, or two R₁₀ groups on adjacent carbon atoms join together to form an optionally substituted aromatic ring or an optionally substituted carbocyclic or heterocyclic non-aromatic ring. In certain other embodiments, two R₁₀ groups on adjacent carbon atoms join together to form an optionally substituted non-aromatic heterocyclic ring. In certain embodiments the optionally substituted non-aromatic heterocyclic groups is optionally substituted tetrahydropyranyl or optionally substituted dihydropyranyl. In certain other embodiments the non-aromatic heterocyclic ring is optionally substituted with one or more substituents selected from the group ═O, —OH, C1-C4 alkyl, optionally substituted aryl, —OC(O)(C1-C4 alkyl), —OC(O)(aryl), —OC(O)(substituted aryl), —OC(O)(aralkyl), and —OC(O)(substituted aralkyl).

As used herein an unsubstituted ring carbon atom, is a ring carbon atom which is bonded to a hydrogen atom.

In one embodiment, the optionally phenol containing monomer is represented by:

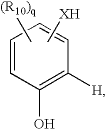

R₁₀, X and q are as described above.

In certain embodiments the phenol containing monomer is represented by one of the following structural formulas:

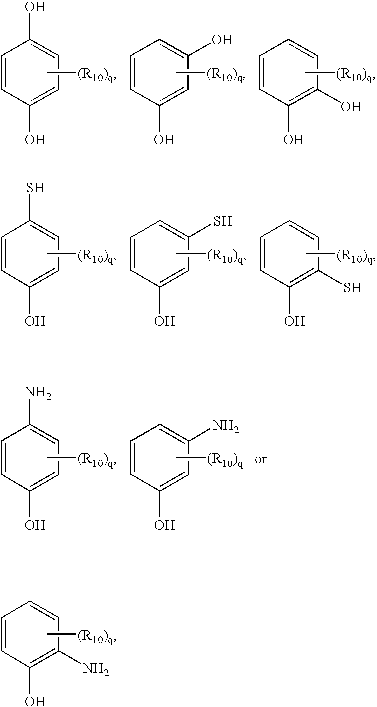

In certain embodiments, the phenol containing monomer is represented by one of the following structural formulas:

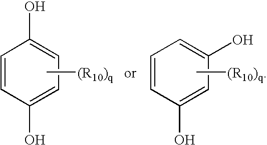

In certain embodiments, the phenol containing monomer is represented by the following structural formula:

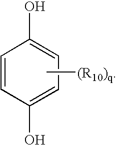

R₁₀ and q are as defined above. Preferably each R₁₀ is independently selected from the groups comprising an optionally substituted C1-C10 alkyl group, an optionally substituted aryl group, an optionally substituted alkoxy group, an optionally substituted alkoxycarbonyl group, an optionally substituted aryloxycarbonyl group, —OH, —SH or —NH₂. More preferably each R₁₀ is independently selected from the groups comprising a tertiary alkyl group (e.g., tert-butyl), an alkoxy carbonyl group or a hydroxy group. q is preferably 0 or 1.

In certain embodiments each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂ or two R₁₀ groups on adjacent carbon atoms join together to form an optionally substituted aromatic ring or an optionally substituted carbocyclic or heterocyclic non-aromatic.

In certain embodiments, each R₁₀ is independently C1-C10 alkyl group, —OH, —SH or —NH₂, or two R₁₀ groups on adjacent carbon atoms join together to form an optionally substituted aromatic ring or an optionally substituted carbocyclic or heterocyclic non-aromatic ring. In certain other embodiments, two R₁₀ groups on adjacent carbon atoms join together to form an optionally substituted non-aromatic heterocyclic ring. In certain embodiments the optionally substituted non-aromatic heterocyclic groups is optionally substituted tetrahydropyranyl or optionally substituted dihydropyranyl. In certain other embodiments the non-aromatic heterocyclic ring is optionally substituted with one or more substituents selected from the group ═O, —OH, C1-C4 alkyl, optionally substituted aryl, —OC(O)(C1-C4 alkyl), —OC(O)(aryl), —OC(O)(substituted aryl), —OC(O)(aralkyl), and —OC(O)(substituted aralkyl).

In certain embodiments, the phenol containing monomer represented by the following structural formula:

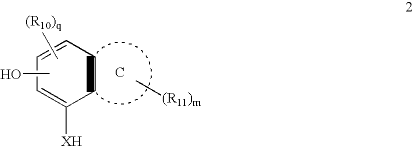

In certain embodiments, Ring C is s five or six membered aromatic or carbocyclic or heterocyclic non-aromatic ring. In certain other embodiments Ring C is a non-aromatic heterocyclic ring. In certain embodiments Ring C is tetrahydropyranyl or dihydropyranyl.

In certain embodiments each R₁₀ is independently C1-C10 alkyl group, —OH, —SH or —NH₂. q is 0 or 1.

In certain other embodiments R₁₁ is ═O, —OH, C1-C3 alkyl, optionally substituted aryl, —OC(O)(C1-C3 alkyl), —OC(O)(aryl), —OC(O)(substituted aryl), —OC(O)(aralkyl), or —OC(O)(substituted aralkyl). In certain other embodiments R₁₁ is ═O, —OH, optionally substituted aryl or —OC(O)(aryl), —OC(O)(substituted aryl). In certain other embodiments R₁₁ is ═O, —OH, optionally substituted phenyl or —OC(O)(phenyl), —OC(O)(substituted phenyl). In certain other embodiments R₁₁ is ═O, —OH, phenol, benzene-diol (pyrocatechol), benzene-triol, —OC(O)(phenol), —OC(O)(benzene-diol), or —OC(O)(benzene-triol,).

m is an integer from 0 to 3.

In certain embodiments, the phenol containing monomer represented by the following structural formula:

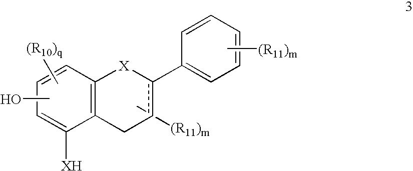

The variables are as described above for structural formula 2. The dashed line represents a double or single bond.

In certain embodiments, the phenol containing monomer represented by the following structural formula:

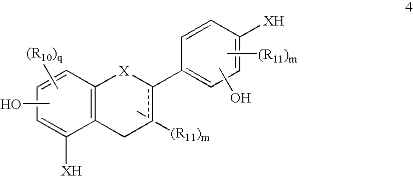

The variables are as described above for structural formula 2. The dashed line represents a double or single bond.

In certain embodiments, the variables and descriptions for the phenol containing monomer described herein are as described above for structural formula 1.

An oxidative polymerization catalyst is added along with an oxidant, e.g., hydrogen peroxide or organic peroxide to convert the monomer to a polymer.

As used herein the oxidant serves as a substrate for the catalyst. The oxidative polymerization catalyst and oxidant combined facilitate the oxidation of the monomer to form a polymer.

Polymerization of the monomers can be catalyzed by a natural or synthetic enzyme or an enzyme mimetic capable of polymerizing a substituted benzene compound in the presence of hydrogen peroxide, where the enzyme or enzyme mimetic typically have a heme or related group at the active site. One general class of enzymes capable of catalyzing this reaction can be commonly referred to as the peroxidases. Horseradish peroxidase, soybean peroxidase, Coprinus cinereus peroxidase, and Arthromyces ramosus peroxidase are readily available peroxidases. Other enzymes capable of catalyzing the reaction include laccase, tyrosinase, and lipases. Suitable enzymes are able to catalyze the formation of a carbon-carbon bond and/or a carbon-oxygen-carbon bond between two aryl (e.g., phenyl, phenol) groups when a peroxide (e.g., hydrogen peroxide or an organic peroxide) can be present. A subunit or other portion of a peroxidase can be acceptable, provided that the active site of the enzyme can be still functional. Enzyme mimetics typically correspond to a part of an enzyme, so that they can carry out the same reaction as the parent enzyme but are generally smaller than the parent enzyme. Also, enzyme mimetics can be designed to be more robust than the parent enzyme, such as to be functional under a wider variety of conditions (e.g., different pH range, aqueous, partically aqueous and non-aqueous solvents) and less subject to degradation or inactivation. Suitable enzyme mimetics include hematin, tyrosinase-model complexes and iron-salen complexes. Hematin, in particular, can be functionalized to allow it to be soluble under a wider variety of conditions is disclosed in U.S. application Ser. No. 09/994,998, filed Nov. 27, 2001, the entire teachings of which are incorporated herein by reference.

Polymerizations of the present invention can be carried out under a wide variety of conditions. The pH can be often between about pH 1.0 and about pH 12.0, typically between about pH 6.0 and about pH 11.0. The temperature can be above about 0° C., such as between about 0° C. and about 100° C., 0° C. and about 45° C. or between about 15° C. and about 30° C. (e.g., room temperature). The solvent can be aqueous (preferably buffered), organic, or a combination thereof. Organic solvents are typically polar solvents such as ethanol, methanol, isopropanol, dimethylformamide, dioxane, acetonitrile, and diethyl ether. The concentration of monomer or comonomers can be typically 0.001 M or greater. Also, the concentration of buffer can be typically 0.001 M or greater. The polymerization reaction is typically carried out for between 1 and 48 hours, between 10 and 40 hours, between 15 and 35 hours, or between 20 and 30 hours.

Polymerizations of the invention use a catalytic amount of one of the enzymes or enzyme mimetics described above, which can be between about one unit/mL and five units/mL, where one unit can form 1.0 mg purpurogallin from pyrogallol in 20 seconds at pH 6.0 at 20° C. Preferably, the enzyme or enzyme mimetic can be added to the solution after addition of the antioxidant monomer or comonomers. A peroxide can be then added incrementally to the reaction mixture, such as not to de-activate the enzyme or enzyme mimetic, until an amount approximately stoichiometric with the amount of antioxidant monomer or comonomers has been added.

Although the enzyme or enzyme mimetic can be responsible for formation of phenol-based free radicals needed for chain propagation, the coupling of radicals to form a polymer chain can be controlled by the phenoxy radical and solvent chemistries. Further details regarding the coupling of phenoxy radicals can be found in “Enzymatic catalysis in monophasic organic solvents,” Dordick, J. S., Enzyme Microb. Technol. 11:194-211 (1989), the contents of which are incorporated herein by reference. Coupling between substituted benzene monomers typically occurs ortho and/or para to a hydroxyl group. Coupling rarely occurs meta to a hydroxyl group.

Polymerization preferably results in the formation of C—C bonds. Preferred polymers can contain at least about 95% C—C bonds, at least about 90% C—C bonds, at least about 80% C—C bonds, at least about 70% C—C bonds, at least about 60% C—C bonds or at least about 50% C—C bonds. Especially preferred polymers contain about 100% C—C bonds. The remaining bonds are typically C—O—C bonds.

In certain embodiments of the present invention addition of biocatalyst or biomimatic [horseradish peroxidase (HRP), soybean peroxidase, Iron(II)-salen, hematin, and other peroxidases] and hydrogen peroxide (drop wise addition) to the reaction mixture results in the polymerization of the monomer.

In certain other embodiments the polymerization is carried out in the presence of an inorganic or organometallic catalyst, such as ferric chloride, ammonium persulphate, Iron(III) chloride, Iron(III) bromide, aluminum chloride, zinc chloride, TEMPO, AIBN, bis(cyclopentadienyl)titanium dichloride, 2.di-alkyl-aluminimum, chloride compounds, 3.triethyl aluminum and titanium tetra chloride, 4.Bis-Cyclopentadienyl, Zirconium Dichloride and 5 Ta(CH-t-Bu)(CH2-t-Bu)₃.

In various embodiments, the monomer for the polymerization can be, for example, a derivative of phenol, aniline, benzenethiol, hydroquinone, mono-protected hydroquinone, aminophenol, 4-aminophenol, phloroglucinol, querectin, epicatechin, epigallocatechin, epicatechingallate and any other polyphenolic, hydroxyl-aniline and hydroxyl-benezethiol system having at least one free ortho-position relative to the phenolic hydroxyl, and their combinations.

In various embodiments, the polymerization can be through, for example, a derivative of phenol, aniline and benzenethiol systems and their combinations.

In certain embodiments the present invention is a method for the synthesis of the macromolecules where the monomer for the polymerization could be, but is not limited to hydroquinone, mono-protected hydroquinone, 4-aminophenol, phloroglucinol, querectin, epicatechin, epigallocatechin, epicatechingallate and any other polyphenolic, hydroxyl-aniline and hydroxyl-benezethiol system having at least one free ortho-position with respect to the phenolic hydroxyl and their combinations.

The resulting polymeric macromolecule can be represented by one or both of Structural Formulas R and S:

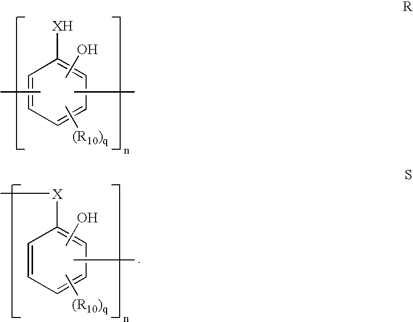

In Structural Formulas R and S, n is an integer equal to or greater than 2, or the sum of two or more ns is an integer equal to or greater than 2.

The variables X, R₁₀ and q are as defined above. In certain embodiments at least one ring carbon atom substituted with an —OH (or —NH₂ or —SH) group (e.g., >C—OH) is adjacent (or ortho) to one unsubstituted ring carbon atom (>C—H). In certain embodiments at least one ring carbon atom substituted with an —OH (or —NH₂ or —SH) group (e.g, >C—OH) is meta orpara to one unsubstituted ring carbon atom (>C—H).

The methods of the present invention further include a second step of alkylation at a ring carbon atom adjacent (ortho) to a ring carbon atom substituted with a phenolic hydroxyl (or amine or thiol) group of the macromolecule represented by one or both of Structural Formulas R and S, resulting in a sterically hindered polymeric macromolecular antioxidant wherein at least one >C—OH (or >C—NH₂ or >C—SH) is adjacent to a >C-C1-C10 alkyl group, e.g., a tertiary butyl group.

The methods of the present invention further include a second step of alkylation at a ring carbon atom meta to a ring carbon atom substituted with a phenolic hydroxyl (or amine or thiol) group of the macromolecule represented by one or both of Structural Formulas R and S, resulting in a sterically hindered polymeric macromolecular antioxidant wherein at least one >C—OH, (or >C—NH₂ or >C—SH) is meta t to a >C-C1-C10 alkyl group, e.g., a tertiary butyl group.

The methods of the present invention further include a second step of alkylation at a ring carbon atom para to a ring carbon atom substituted with a phenolic hydroxyl (or amine or thiol) group of the macromolecule represented by one or both of Structural Formulas R and S, resulting in a sterically hindered polymeric macromolecular antioxidant wherein at least one >C—OH, (or >C—NH₂ or >C—SH) is para t to a >C-C1-C10 alkyl group, e.g., a tertiary butyl group.

In certain embodiments the alkylation step results in a polymers comprising at least one repeat unit selected form:

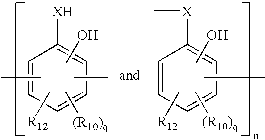

R₁₂ is a bulky alkyl group. In certain embodiments, R₁₂ is a tert-butyl group. In certain embodiments, the tert-butyl group is adjacent (or ortho) to an —OH, —SH or —NH₂ group. In certain embodiments, the tert-butyl group is adjacent (or ortho) to an —OH group. In certain embodiments, the tert-butyl group is meta orpara to an —OH, —SH or —NH₂ group.

In certain embodiments, an aryl group is added to the polymer repeat units represented by R and/or S which results in a polymers comprising at least one repeat unit selected form: 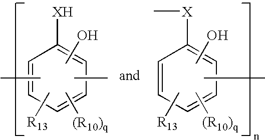
R₁₃ is an aryl group. In certain embodiments, the aryl group is adjacent (or ortho) to an —OH, —SH or —NH₂ group. In certain embodiments, the aryl group is adjacent (or ortho) to an —OH group. In certain embodiments, the aryl group is meta orpara to an —OH, —SH or —NH₂ group.

In certain embodiments the second step of alkylation at a ring carbon atom may occur meta orpara to a ring carbon atom substituted with a phenolic hydroxyl group of the macromolecule represented by one or both of Structural Formulas R and S, resulting in a sterically hindered polymeric macromolecular antioxidant wherein at least one >C—OH is meta orpara to a >C-C1-C10 alkyl group, e.g., a tertiary butyl group.

These polymeric sterically hindered macromolecular antioxidants can be or can contain, for example, tert-butylhydroquinone (BHT), 2,5-di-tert-butylhydroquinone, or other BHT type repeat units and their combinations. In some embodiments, homopolymers, copolymers, terpolymers, and the like of these monomers can be synthesized.

In a specific embodiment, the group added by alkylation is a tertiary butyl group ortho to a phenolic hydroxy group. This ortho alkyl group sterically hinders the phenol hydroxyl group,

In various embodiments, the macromolecules are alkylated with bulky alkyl groups by reaction with alcohols (e.g., t-butanol, isobutanol etc.), alkenes (e.g., isobutene, styrene, diisobutylene, etc.,), alkyl halides (e.g., 2-chloro-2-methylpropane, 2-bromo-2-methylpropane, 2-iodo-2-methylpropane, benzyl chloride, t-butyl chloride etc.) and the like in the presence of appropriate catalysts.

In some embodiments, the alkylation reaction can be the substitution of one bulky alkyl group or two bulky alkyl groups for a hydrogen on more repeating units of the polymer. The substitution can be controlled by reaction conditions. In certain embodiments by carrying the temperature, molar ratio of alkylating agent with respect to the polymer and catalyst, selectivity can be achieved with respect to mon t-butylation or di-t-butylation. In various embodiments the alkyl catalyst can be, for example, strong inorganic acids (O. N. Tsevktov, K. D. Kovenev, Int. J. Chem. Eng. 6 (1966), 328), metal-oxides(Sartori Giovanni, Franca Bigi et al., Chem. Ind. (London), 1985 (22)762-763.), Al-salt catalyst(V. A. Koshchii, Ya.B Kozlikovskii, A. A Matyusha,Zh. Org. Khim. 24(7), 1988, 1508-1512), cation-exchange resins(Gokul K. Chandra, M. M. Sharma, Catal. Lett. 19(4), 1993, 309-317), sulfated zirconia(Sakthivel, Ayyamperumal;Saritha, Nellutla;Selvam,Parasuraman, Catal. Lett. 72(3), 2001, 225-228; V. Quaschning, J. Deutsch, P. Druska, H.-J. Niclas and E. Kemnitz. J. Catal. 177 (1998), p. 164), molecular sieves including mordenite(S. K. Badamali, S. Sakthivel and P. Selvam. Catal. Today 63 (2000), p. 291), silica gel/nafion(A. Heidekum, M. A. Hamm and F. Hoelderich. J. Catal. 188 (1999), p. 230), mesoporous silica(Y. Kamitori, M. Hojo, R. Matsuda, T. Izumi and S. Tsukamoto. J. Org. Chem. 49 (1984), p. 4165), zeolites(E. Armengol, A. Corma, H. Garcia and J. Primo. Appl. Catal. A 149 (1997), p. 411), metal halide(J.-M. Lalancette, M.-J. Fournier and R. Thiffault. Can. J. Chem. 52 (1974), p. 589) and the like. The entire contents of each of the above listed documents are incorporated herein by reference in their entirety.

In certain embodiments, for the phenol containing monomer described herein the ring carbon atom substituted with an —OH, —SH or NH₂ group is not adjacent (or ortho) to one unsubstituted ring carbon atom. In certain embodiments the polymers made by the present invention do not have a bulky alkyl group or aryl group adjacent to the —OH, —SH or NH₂ group. In certain embodiments, in the polymers made by methods of the present invention the bulky alkyl or aryl group is meta orpara to the —OH, —SH or NH₂ group. Without wishing to be bound by any theory it is believe that presence of the bulky group ortho, meta orpara to a hydroxy group (or amino or thiol group) increases the antioxidant activity of the compound. Preferably the bulky group is ortho to the hydroxy group (or amino or thiol group).

In one embodiment, the present invention relates to a simple process for the synthesis of macromolecular antioxidants based on sterically hindered phenol type antioxidant units. The process involves two steps; first step involves the polymerization of monomeric system such as polyphenolic, amino-phenol or hydroxyl-benzenethiol having at least one free ortho-position with respect to phenolic hydroxyl group. The macromolecule may contain Structures I, II or both. 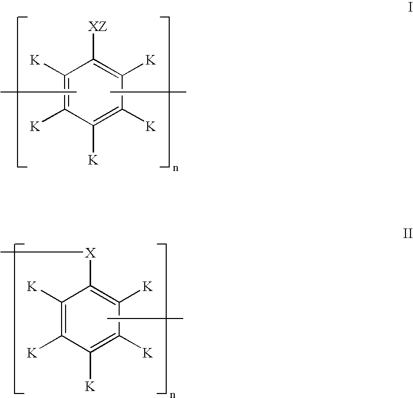
wherein: n is an integer equal to or greater than 2; X≡O—, —NH—, —S—; Z=H; K═H, OH with at least one OH adjacent to H.

The second step involves the alkylation of this macromolecule with bulky alkyl group at free ortho position/s with respect to phenolic hydroxyl group. Tertiary butyl group is especially desirable in the invention herein. This step results in placement of the bulky alkyl group/s adjacent to phenolic hydroxyl group and the phenol hydroxyl group become sterically hindered and this imparts antioxidant properties to the macromolecules containing structure I, II or both.

In certain embodiments of the present, the macromolecular antioxidant contains one or both units shown in Structure III, IV.

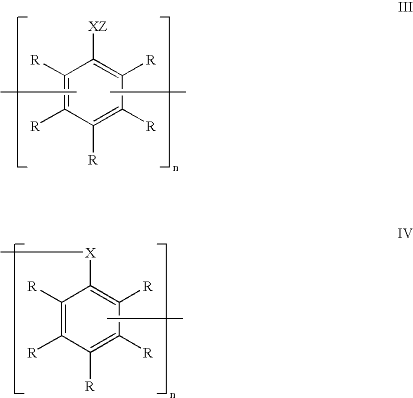

wherein: n is an integer equal to or greater than 2; X≡O—, —NH—, —S—; Z=—H; R═C₁₋₁₀ alkyl group, OH, H or a bond wherein at least one R adjacent to OH is bulky alkyl group.

The present invention allows synthesizing macromolecular antioxidants containing tert-butylhyroquinone, 2,5-di-tert-butylhydroquinone, BHT type repeat units and their combinations. The present invention describes the synthesis of homopolymer, copolymer, terpolymer etc. The formation of macromolecular antioxidant are illustrated with examples described herein.

In a specific embodiment, the antioxidant polymer prepared by the methods of the present invention is represented by one or both of Structural Formulas (Ia)-(Id), and (IIa)-(IId):

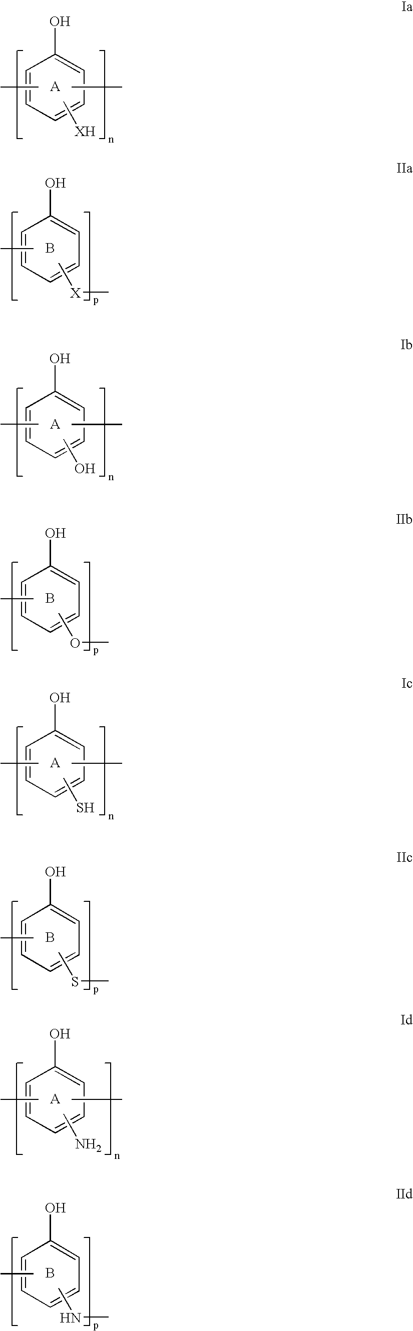

Ring A is substituted with at least one bulky alkyl group preferably a tert-butyl group ortho to the phenolic hydroxy group, and ring A is optionally further substituted with one or more groups selected from a substituted or unsubstituted alkyl or aryl group and a substituted or unsubstituted alkoxycarbonyl group. Ring A is further optionally fused to at least one more optionally substituted aromatic or optionally substituted non-aromatic carbocyclic or heterocyclic group.

Ring B is substituted with at least one —H and at least one bulky group preferably a tert-butyl group ortho to the phenolic hydroxy group, and ring B is further optionally substituted with one or more groups selected from a substituted or unsubstituted alkyl or aryl group and a substituted or unsubstituted alkoxycarbonyl group. Ring B is further optionally fused to at least one more optionally substituted aromatic or optionally substituted non-aromatic carbocyclic or heterocyclic group.

In various embodiments, the alkyl groups substituting Rings A and B can be, for example, secondary and tertiary alkyl groups containing 3 to 10 carbon atoms, typically between 3 and 6. In some embodiments, the alkyl groups are tertiary butyl groups.

X is —O—, —S— or —NH—.

n is an integer equal to or greater than 2; and

p is an integer equal to or greater than 0, wherein the sum of n and p is an integer greater than or equal to 2.

In another embodiment, the antioxidant polymer prepared by the methods of the present invention is represented by one or both of Structural Formulas (I), and (II): 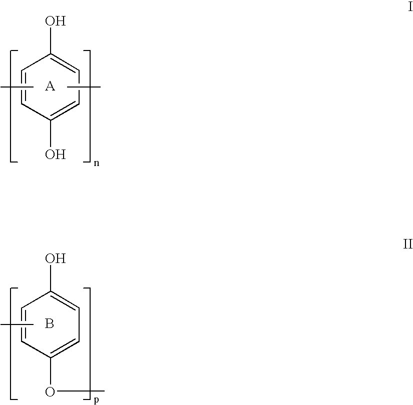
where:

Ring A, Ring B, p and n are as described above

Preferred polymers synthesized by the methods of the present invention include repeat units represented by one or both of Structural Formulas (III) and (IVa): 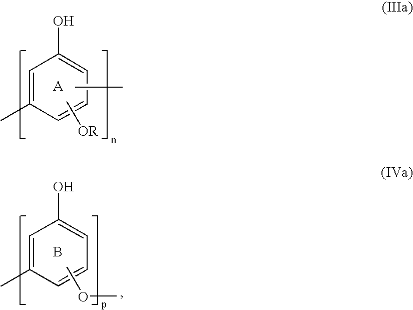
where Rings A and B are substituted as described above and n and p are as defined above.

Preferably, Ring A and Ring B in Structural Formulas (I) to (IV) are each substituted with at least one tert-butyl group located adjacent to the —OH.

R is —H or —CH₃.

Preferred polymers synthesized by the methods of the present invention include repeat units represented by one or both of Structural Formulas (III) and (IV): 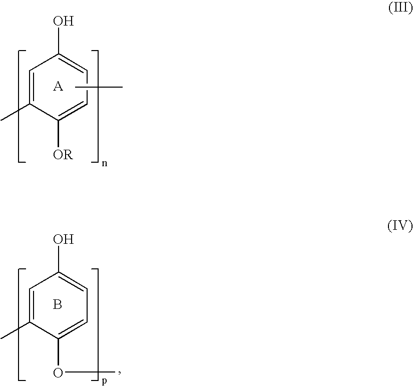
where Rings A and B are substituted as described above and R, n and p are as defined above.

The polymers made by the methods of the present invention can include repeat units represented by one or more of Structural Formulas (Va), (Vb), (Vc), (VIa), (VIb) and (VIc): 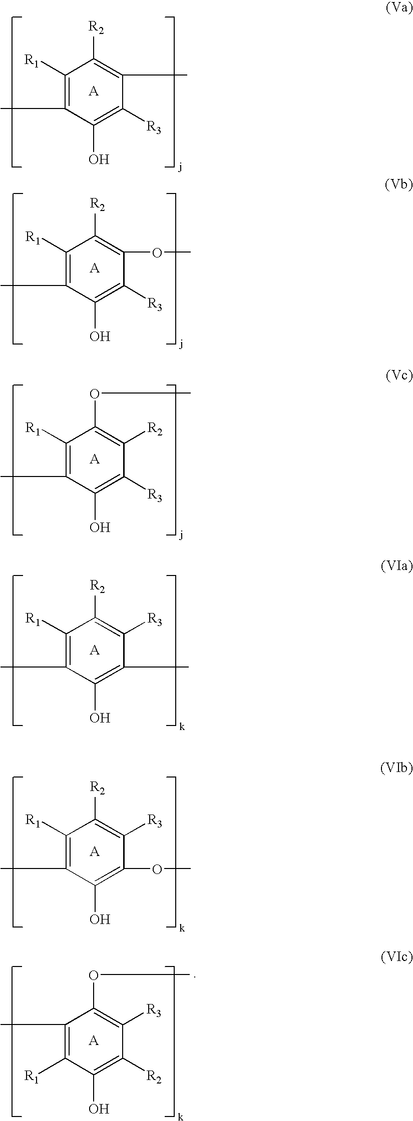
Where R₁, R₂ and R₃ are independently selected from the group consisting of —H, —OH, —NH, —SH, a substituted or unsubstituted alkyl or aryl group, and a substituted or unsubstituted alkoxycarbonyl group, additional values for R₁, R₂ and R₃ include cakoxy and carbonyl. Preferably at least one of R₁, R₂ and R₃ is a tert-butyl group. Preferably the tert-butyl group is adjacent to an —OH group; and j and k are independently integers of zero or greater, such that the sum of j and k is equal to or greater than 2. In certain embodiments, in Va and VIa at least one of R₁, R₂ and R₃ are independently selected from the group consisting of —OH, —NH or —SH

R is —H or —CH₃.

In a specific embodiment, R is —H or —CH₃; R₂ is —H, —OH, or a substituted or unsubstituted alkyl group; or both. Preferably R is —H.

Specific examples of repeat units included in polymers of the present invention are represented by one of the following structural formulas:

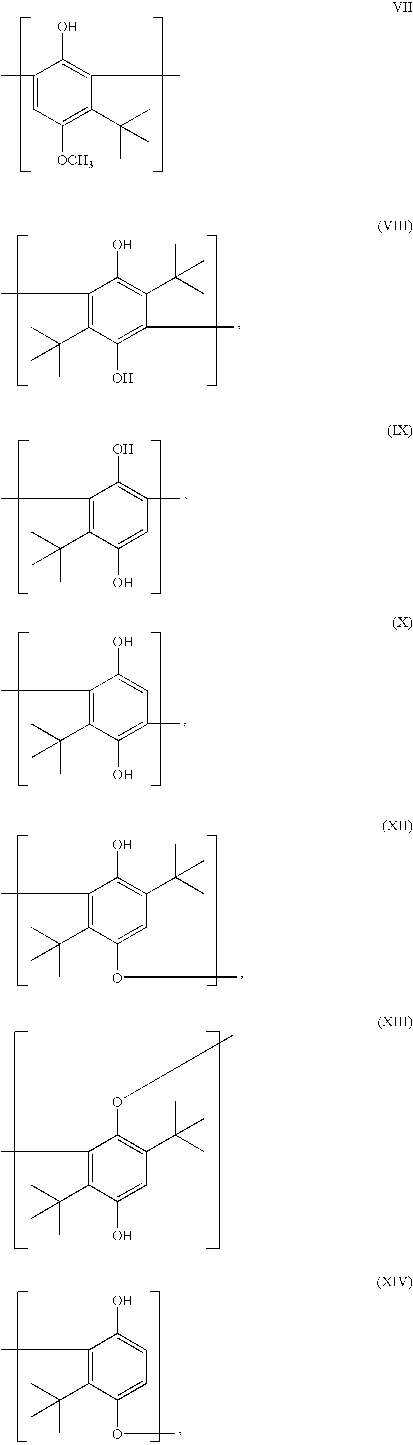

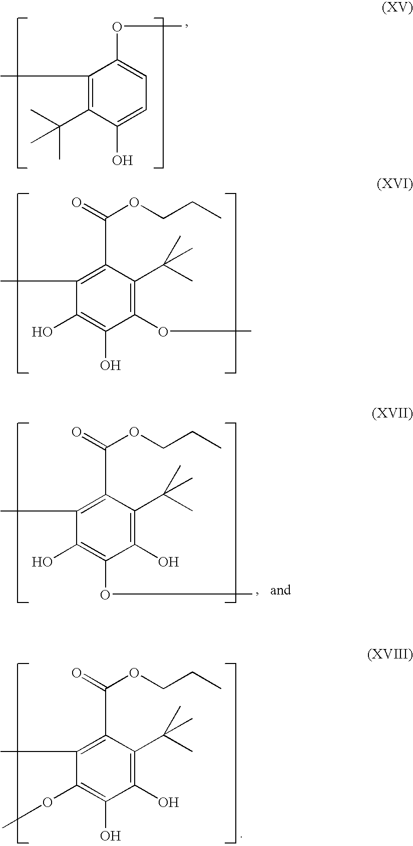

Advantageously, a polymer made by the methods of the present invention consists of repeat units represented by one or more of Structural Formulas (VII) to (XVIII).

Antioxidant polymers made by the methods of the present invention are prepared by polymerizing a molecule represented by Structural Formula (XIX): 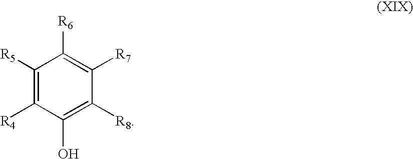
In certain embodiments, XIX R₅-R₈ are independently selected from —OH, —SH, —NH₂, or —OH, —SH, —NH₂ wherein one hydrogen atom is replaced with a protecting group selected from alkyl, alkoxy, benzyl, benzoyl, THP, carbonate, acetal, ketal, tretyl, dimethoxytretyl, trimethoxytretyl, silyl etc. Preferably, a molecule represented by Structural Formula (XIX) has one, two, three, four or five of the following features. In the first feature, at least one of R₅-R₈ are independently selected from —OH, —SH, —NH₂ and at least one of R₅, R₇ and R₈ is a tert-butyl group. In the second feature, R₄ is —H. In the third feature, one or both of R₇ and R₈ is —H. In the fourth feature, R is —H or —CH₃. In the fifth feature, R₆ is —H, —OH or a substituted or unsubstituted alkyl group. More preferably, a molecule represented by Structural Formula (XIX) has the first and second features; the first, second and third features; the first, second, third and fourth features; or the first, second, third, fourth and fifth features.

Specific examples of monomers that can be polymerized to form an antioxidant polymer of the present invention are represented by one of the following structural formulas:

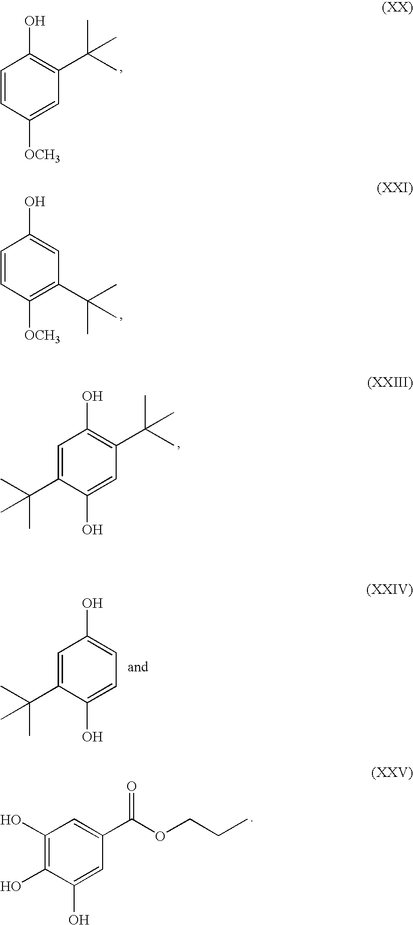

Other examples of specific monomers that can be polymerized to form an antioxidant polymer of the present invention are represented by one of the following structural formulas:

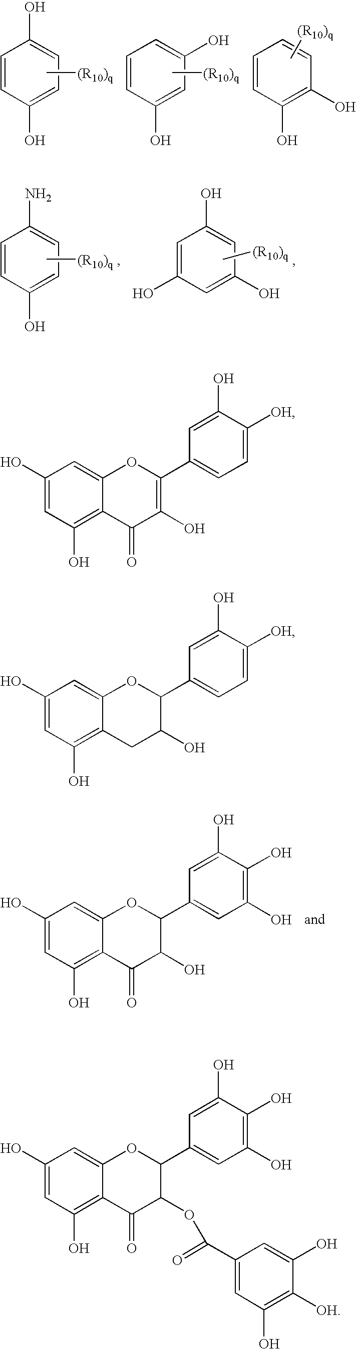

In all of the examples of monomers and polymers described herein the —OH groups can be replaced with OR, —NH₂, —NHR, —SH or —SR groups wherein R is as defined above.

In certain embodiments, examples of sterically hindered polymeric macromolecular antioxidant produced by the methods of the present invention comprises at least one repeat unit selected from:

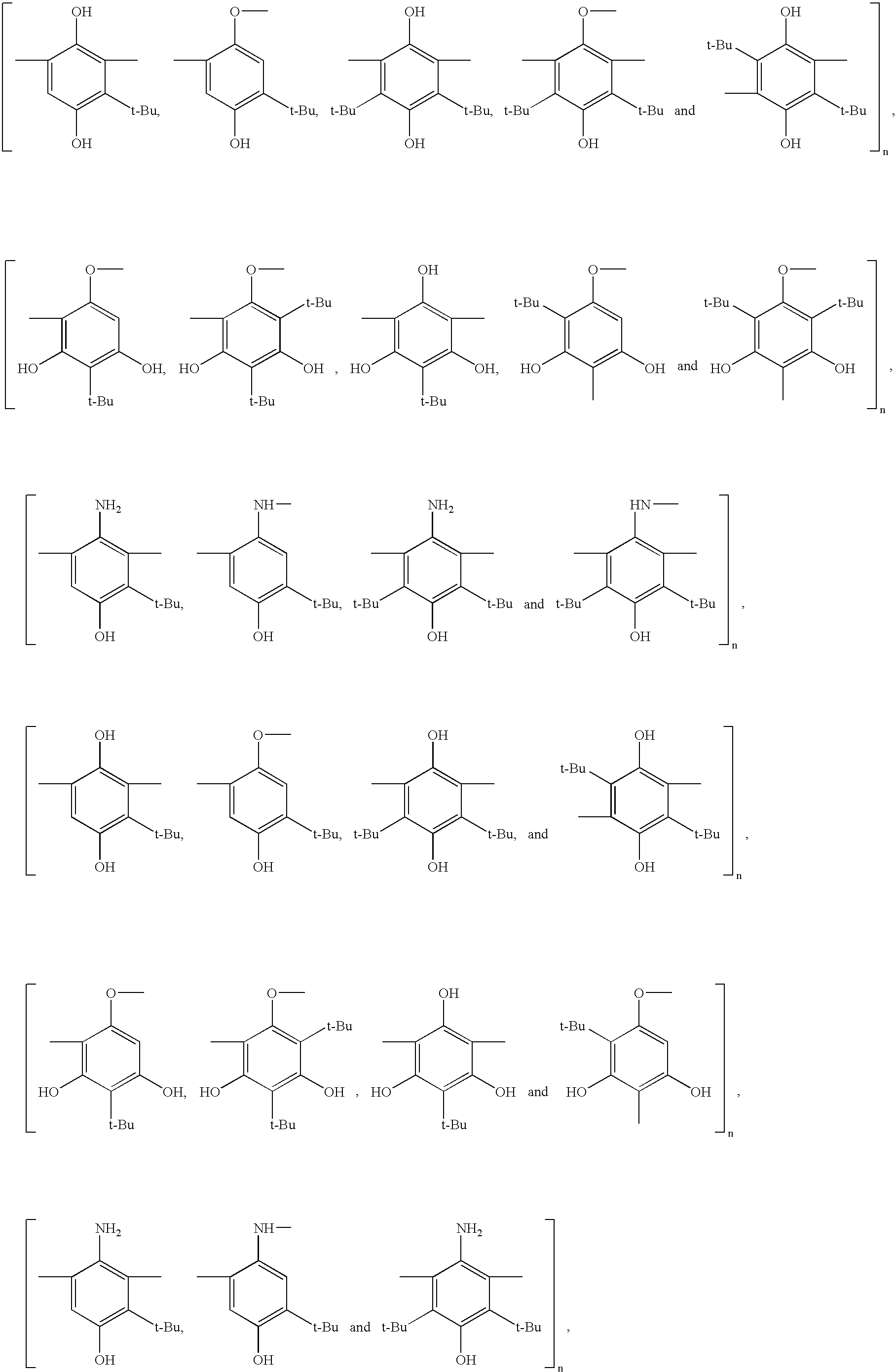

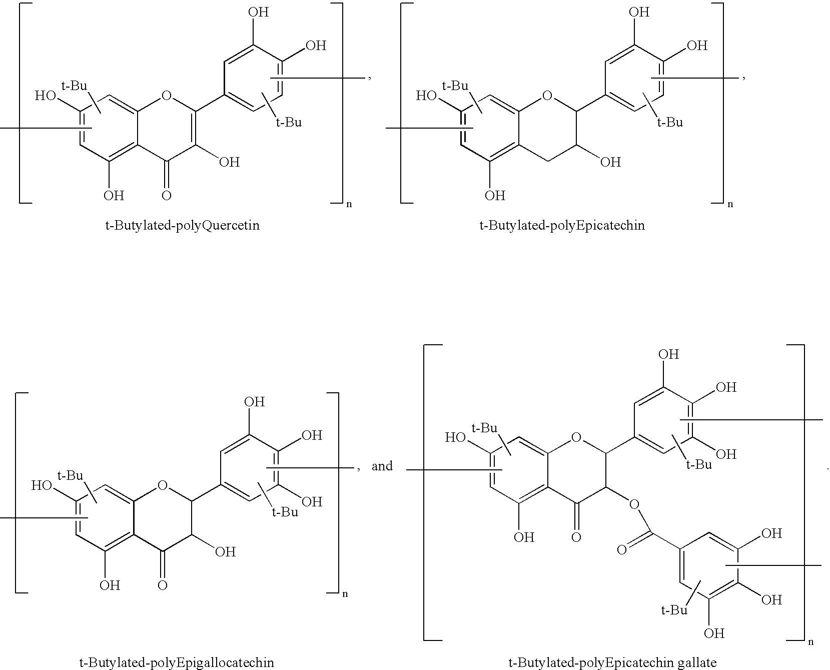

The method includes the polymerization of a monomer having at least one free ortho-position with respect to a phenolic hydroxyl group, such as a polyphenol, an amino-phenol, or a hydroxyl-benzenethiol. The resulting macromolecule can be represented by one or both of Structural Formulas R and S:

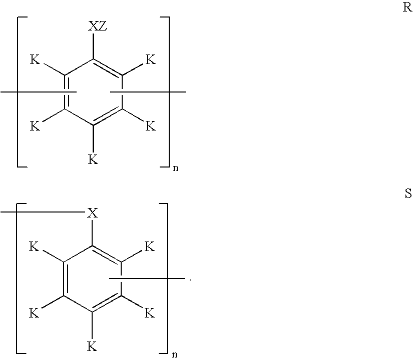

In Structural Formulas R and S, n is an integer equal to or greater than 2.

The variable X is O, NH, or S.

The variable Z is H.

Each variable K is independently —H or —OH, with at least one —OH adjacent to a —H; or K is a bond when that position is involved in the polymer chain.

The method also includes alkylation of the macromolecule represented by one or both of Structural Formulas R and S with an alkyl group at free ortho position/s with respect to the phenolic hydroxyl group. In a preferred embodiment, the group added by alkylation is a tertiary butyl group. This ortho alkyl group sterically hinders the phenol hydroxyl group, resulting in a macromolecular antioxidant by one or both of Structural Formulas T and U:

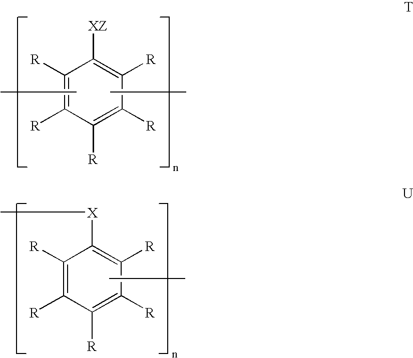

In Structural Formulas T and U, n is an integer equal to or greater than 2.

The variable X is O, NH, or S.

The variable Z is H.

Each variable R is independently —H, —OH, a C1-C10 alkyl group, or a bond when that position is involved in the polymer chain wherein at least one —OH is adjacent to a C1-C10 alkyl group, e.g., a tertiary butyl group.

These macromolecular antioxidants can be synthesized to contain tert-butylhydroquinone, 2,5-di-tert-butylhydroquinone, BHT type repeat units and their combinations. In some embodiments, homopolymers, copolymers, terpolymers, and the like of these monomers can be synthesized. The invention provides a process for preparing these antioxidant polymers.

In various embodiments, the sterically hindered phenol type antioxidant units can be, for example, substituted/unsubstituted tert-butylhydroquinone (t-BHQ) and/or substituted/unsubstituted butyl (BHT) and/or substituted/unsubstituted 2,5 di-tert-butylhydroquinone (2,5 di-t-BHQ) types and their combinations.

In various embodiments, the monomer for the polymerization can be, for example, hydroquinone, mono-protected hydroquinone, 4-aminophenol, phloroglucinol, querectin, epicatechin, epigallocatechin, epicatechingallate and any other polyphenolic, hydroxyl-aniline and hydroxyl-benezethiol system having at least one free ortho-position relative to the phenolic hydroxyl, and their combinations.

In various embodiments, the polymerization can be through, for example, phenol, aniline and benzenethiol systems and their combinations.

In various embodiments, catalysts used for polymerization can be, for example, enzymes, enzyme mimetics, and the like. In various embodiments, the enzyme or enzyme mimetic used for polymerization can be, for example, Iron(II)-salen complexes, horseradish peroxidase (HRP), soybean peroxidase (SBP), hematin, laccase, tyroniase, tyroniase-model complexes, other peroxidase, and the like.

In various embodiments, the macromolecules are alkylated with bulky alkyl groups by reaction with alcohol, alkenes, alkyl halide, and the like in the presence of appropriate catalysts.

In some embodiments, the alkylation reaction can be the substitution of one bulky alkyl group or two bulky alkyl group or more per repeating unit. The substitution can be controlled by reaction conditions. In various embodiments the alkyl catalyst can be, for example, strong inorganic acids (O. N. Tsevktov, K. D. Kovenev, Int. J. Chem. Eng. 6 (1966), 328), metal-oxides(Sartori Giovanni, Franca Bigi et al., Chem. Ind. (London), 1985 (22)762-763.), Al-salt catalyst(V. A. Koshchii, Ya.B Kozlikovskii, A. A Matyusha, Zh. Org. Khim. 24(7), 1988, 1508-1512), cation-exchange resins(Gokul K. Chandra, M. M. Sharma, Catal. Lett. 19(4), 1993, 309-317), sulfated zirconia(Sakthivel, Ayyamperumal;Saritha, Nellutla;Selvam,Parasuraman, Catal. Lett. 72(3), 2001, 225-228; V. Quaschning, J. Deutsch, P. Druska, H.-J. Niclas and E. Kemnitz. J. Catal. 177 (1998), p. 164), molecular sieves including mordenite(S. K. Badamali, S. Sakthivel and P. Selvam. Catal. Today 63 (2000), p. 291), silica gel/nafion(A. Heidekum, M. A. Hamm and F. Hoelderich. J. Catal. 188 (1999), p. 230), mesoporous silica(Y. Kamitori, M. Hojo, R. Matsuda, T. Izumi and S. Tsukamoto. J. Org. Chem. 49 (1984), p. 4165), zeolites(E. Armengol, A. Corma, H. Garcia and J. Primo. Appl. Catal. A 149 (1997), p. 411), metal halide(J.-M. Lalancette, M.-J. Fournier and R. Thiffault. Can. J. Chem. 52 (1974), p. 589) and the like.

The present invention relates to a simple process for the synthesis of macromolecular antioxidants based on sterically hindered phenol type antioxidant units.

The process involves two steps; first step involves the polymerization of monomeric system such as polyphenolic, amino-phenol or hydroxyl-benzenethiol having at least one free ortho-position with respect to phenolic hydroxyl group. The macromolecule may contain Structures I, II or both.

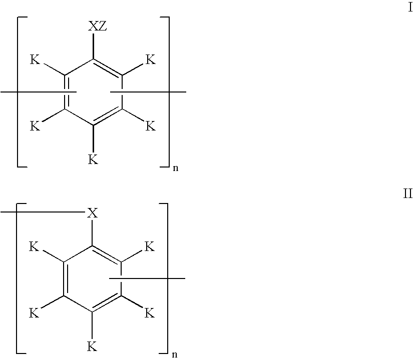

where

n is an integer equal to or greater than 2

X═O,NH,S

Z=H

K═H, OH with at least one OH adjacent to H.

The second step involves the alkylation of this macromolecule with bulky alkyl group at free ortho position/s with respect to phenolic hydroxyl group. Tertiary butyl group is especially desirable in the invention herein. This step results in placement of the bulky alkyl group/s adjacent to phenolic hydroxyl group and the phenol hydroxyl group become sterically hindered and this imparts antioxidant properties to the macromolecules containing structure I, II or both.

In present invention, the macromolecular antioxidant contains one or both units shown in Structure III, IV. 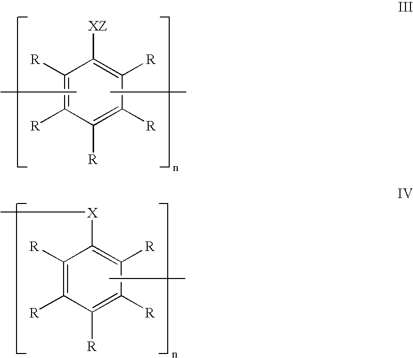
where

n is an integer equal to or greater than 2

X═O,NH,S

Z=H

R═C₁₋₁₀ alkyl group, OH, H or a bond wherein at least one R adjacent to OH is bulky alkyl group.

The present invention allows synthesizing macromolecular antioxidants containing tert-butylhyroquinone, 2,5-di-tert-butylhydroquinone, BHT type repeat units and their combinations. The present invention describes the synthesis of homopolymer, copolymer, terpolymer etc.

Antioxidant polymers of the present invention have two or more repeat units, preferably greater than about five repeat units. The molecular weight of the polymers disclosed herein can be generally selected to be appropriate for the desired application. Typically, the molecular weight can be greater than about 500 atomic mass units (amu) and less than about 2,000,000 amu, greater than about 1,000 amu and less than about 100,000, greater than about 2,000 amu and less than about 10,000, or greater than about 2,000 amu and less than about 5,000 amu. For food or edible products (e.g., products fit for human consumption), the molecular weight can be advantageously selected to be large enough so that an antioxidant polymer cannot be absorbed by the gastrointestinal tract, such as greater than 1,000 amu. For antioxidant polymers blended with a polymeric material, the molecule weight can be advantageously selected such that the rate of diffusion of the antioxidant polymer through the polymeric material can be slow relative to the expected lifetime of the polymeric material.

Antioxidant polymers of the present invention can be either homopolymers or copolymers. A copolymer preferably contains two or more or three or more different repeating monomer units, each of which has varying or identical antioxidant properties. The identity of the repeat units in a copolymer can be chosen to modify the antioxidant properties of the polymer as a whole, thereby giving a polymer with tunable properties. The second, third and/or further repeat units in a copolymer can be either a synthetic or natural antioxidant.

Antioxidant polymers of the present invention are typically insoluble in aqueous media. The solubility of the antioxidant polymers in non-aqueous media (e.g., oils) depends upon the molecular weight of the polymer, such that high molecular weight polymers are typically sparingly soluble in non-aqueous media. When an antioxidant polymer of the invention can be insoluble in a particular medium or substrate, it can be preferably well-mixed with that medium or substrate.

Antioxidant polymers of the present invention can be branched or linear, but are preferably linear. Branched antioxidant polymers can only be formed from benzene molecules having three or fewer substituents (e.g., three or more hydrogen atoms), as in Structural Formulas (XX), (XXI) and (XXIV).

Antioxidant polymers of the present invention can be present in a wide variety of compositions where free radical mediated oxidation leads to deterioration of the quality of the composition, including edible products such as oils, foods (e.g., meat products, dairy products, cereals, etc.), and other products containing fats or other compounds subject to oxidation. Antioxidant polymers can also be present in plastics and other polymers, elastomers (e.g., natural or synthetic rubber), petroleum products (e.g., fossil fuels such as gasoline, kerosene, diesel oil, heating oil, propane, jet fuel), lubricants, paints, pigments or other colored items, soaps and cosmetics (e.g., creams, lotions, hair products). The antioxidant polymers can be used to coat a metal as a rust and corrosion inhibitor. Antioxidant polymers additionally can protect antioxidant vitamins (Vitamin A, Vitamin C, Vitamin E) and pharmaceutical products from degradation. In food products, the antioxidant polymers can prevent rancidity. In plastics, the antioxidant polymers can prevent the plastic from becoming brittle and cracking.

Antioxidant polymers of the present invention can be added to oils to prolong their shelf life and properties. These oils can be formulated as vegetable shortening or margarine. Oils generally come from plant sources and include cottonseed oil, linseed oil, olive oil, palm oil, corn oil, peanut oil, soybean oil, castor oil, coconut oil, safflower oil, sunflower oil, canola (rapeseed) oil and sesame oil. These oils contain one or more unsaturated fatty acids such as caproleic acid, palmitoleic acid, oleic acid, vaccenic acid, elaidic acid, brassidic acid, erucic acid, nervonic acid, linoleic acid, eleosteric acid, alpha-linolenic acid, gamma-linolenic acid, and arachidonic acid, or partially hydrogenated or trans-hydrogenated variants thereof. Antioxidant polymers of the present invention are also advantageously added to food or other consumable products containing one or more of these fatty acids.

The shelf life of many materials and substances contained within the materials, such as packaging materials, are enhanced by the presence of an antioxidant polymer of the present invention. The addition of an antioxidant polymer to a packaging material is believed to provide additional protection to the product contained inside the package. In addition, the properties of many packaging materials themselves, particularly polymers, are enhanced by the presence of an antioxidant regardless of the application (i.e., not limited to use in packaging). Common examples of packaging materials include paper, cardboard and various plastics and polymers. A packaging material can be coated with an antioxidant polymer (e.g., by spraying the antioxidant polymer or by applying as a thin film coating), blended with or mixed with an antioxidant polymer (particularly for polymers), or otherwise have an antioxidant polymer present within it. In one example, a thermoplastic such as polyethylene, polypropylene or polystyrene can be melted in the presence of an antioxidant polymer in order to minimize its degradation during the polymer processing. An antioxidant polymer can also be co-extruded with a polymeric material.

The term “alkyl” as used herein means a saturated straight-chain, branched or cyclic hydrocarbon. When straight-chained or branched, an alkyl group is typically C1-C8, more typically C1-C6; when cyclic, an alkyl group is typically C3-C12, more typically C3-C7 alkyl ester. Examples of alkyl groups include methyl, ethyl, n-propyl, iso-propyl, n-butyl, sec-butyl and tert-butyl and 1,1-dimethylhexyl.

The term “alkoxy” as used herein is represented by —OR**, wherein R** is an alkyl group as defined above.

The term “carbonyl” as used herein is represented by —C(═O)R**, wherein R** is an alkyl group as defined above.

The term “alkoxycarbonyl” as used herein is represented by —C(═O)OR**, wherein R** is an alkyl group as defined above.

The term “aromatic group” includes carbocyclic aromatic rings and heteroaryl rings. The term “aromatic group” may be used interchangeably with the terms “aryl”, “aryl ring” “aromatic ring”, “aryl group” and “aromatic group”.

Carbocyclic aromatic ring groups have only carbon ring atoms (typically six to fourteen) and include monocyclic aromatic rings such as phenyl and fused polycyclic aromatic ring systems in which a carbocyclic aromatic ring is fused to one or more aromatic rings (carbocyclic aromatic or heteroaromatic). Examples include 1-naphthyl, 2-naphthyl, 1-anthracyl and 2-anthracyl. Also included within the scope of the term “carbocyclic aromatic ring”, as it is used herein, is a group in which an aromatic ring is fused to one or more non-aromatic rings (carbocyclic or heterocyclic), such as in an indanyl, phthalimidyl, naphthimidyl, phenanthridinyl, or tetrahydronaphthyl.

The term “heteroaryl”, “heteroaromatic”, “heteroaryl ring”, “heteroaryl group” and “heteroaromatic group”, used alone or as part of a larger moiety as in “heteroaralkyl” refers to heteroaromatic ring groups having five to fourteen members, including monocyclic heteroaromatic rings and polycyclic aromatic rings in which a monocyclic aromatic ring is fused to one or more other aromatic ring (carbocyclic or heterocyclic). Heteroaryl groups have one or more ring heteroatoms. Examples of heteroaryl groups include 2-furanyl, 3-furanyl, N-imidazolyl, 2-imidazolyl, 4-imidazolyl, 5-imidazolyl, 3-isoxazolyl, 4-isoxazolyl, 5-isoxazolyl, oxadiazolyl, oxadiazolyl, 2-oxazolyl, 4-oxazolyl, 5-oxazolyl, N-pyrazolyl, 3-pyrazolyl, 4-pyrazolyl, 5-pyrazolyl, N-pyrrolyl, 2-pyrrolyl, 3-pyrrolyl, 2-pyridyl, 3-pyridyl, 4-pyridyl, 2-pyrimidinyl, 4-pyrimidinyl, 5-pyrimidinyl, 3-pyridazinyl, 4-pyridazinyl, 2-thiazolyl, 4-thiazolyl, 5-thiazolyl, triazolyl, tetrazolyl, 2-thienyl, 3-thienyl, carbazolyl, benzothienyl, benzofuranyl, indolyl, quinolinyl, benzothiazole, benzooxazole, benzimidazolyl, isoquinolinyl and isoindolyl. Also included within the scope of the term “heteroaryl”, as it is used herein, is a group in which an aromatic ring is fused to one or more non-aromatic rings (carbocyclic or heterocyclic).

The term non-aromatic heterocyclic group used alone or as part of a larger moiety refers to non-aromatic heterocyclic ring groups having three to fourteen members, including monocyclic heterocyclcic rings and polycyclic rings in which a monocyclic ring is fused to one or more other non-aromatic carbocyclic or heterocyclic ring or aromatic ring (carbocyclic or heterocyclic). Heterocyclic groups have one or more ring heteroatoms, and can be saturated or unsaturated. Examples of heterocyclic groups include piperidinyl, piperizinyl, pyrrolidinyl, pyrazolidinyl, imidazolidinyl, tetrahydroquinolinyl, inodolinyl, isoindolinyl, tetrahydrofuranyl, oxazolidinyl, thiazolidinyl, dioxolanyl, dithiolanyl, tetrahydropyranyl, dihydropyranyl, azepanyl aNd azetidinyl

The term “heteroatom” means nitrogen, oxygen, or sulfur and includes any oxidized form of nitrogen and sulfur, and the quaternized form of any basic nitrogen. Also the term “nitrogen” includes a substitutable nitrogen of a heteroaryl or non-aromatic heterocyclic group. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl) or NR″ (as in N-substituted pyrrolidinyl), wherein R″ is a suitable substituent for the nitrogen atom in the ring of a non-aromatic nitrogen-containing heterocyclic group, as defined below.

As used herein the term non-aromatic carbocyclic ring as used alone or as part of a larger moiety refers to a non-aromatic carbon containing ring which can be saturated or unsaturated having three to fourteen atoms including monocyclic and polycyclic rings in which the carbocyclic ring can be fused to one or more non-aromatic carbocyclic or heterocyclic rings or one or more aromatic (carbocyclic or heterocyclic) rings

An optionally substituted aryl group as defined herein may contain one or more substitutable ring atoms, such as carbon or nitrogen ring atoms. Examples of suitable substituents on a substitutable ring carbon atom of an aryl group include halogen (e.g., —Br, Cl, I and F), —OH, C1-C3 alkyl, C1-C3 haloalkyl, —NO₂, C1-C3 alkoxy, C1-C3 haloalkoxy, —CN, —NH₂, C1-C3 alkylamino, C1-C3 dialkylamino, —C(O)NH₂, —C(O)NH(C1-C3 alkyl), —C(O)(C1-C3 alkyl), —OC(O)(C1-C3 alkyl), —OC(O)(aryl), —OC(O)(substituted aryl), —OC(O)(aralkyl), —OC(O)(substituted aralkyl), —NHC(O)H, —NHC(O)(C1-C3 alkyl), —C(O)N(C1-C3 alkyl)₂, —NHC(O)O—C1-C3 alkyl), —C(O)OH, —C(O)O—(C1-C3 alkyl), —NHC(O)NH₂, —NHC(O)NH(C1-C3 alkyl), —NHC(O)N(C1-C3 -alkyl)₂, —NH—C(═NH)NH₂, —SO₂NH₂—SO₂NH(C1-C3alkyl), —SO₂N(C1-C3alkyl)₂, NHSO₂H, NHSO₂(C1-C3 alkyl) and optionally substituted aryl. Preferred substituents on aryl groups are as defined throughout the specification. In certain embodiments aryl groups are unsubstituted.

Examples of suitable substituents on a substitutable ring nitrogen atom of an aryl group include C1-C3 alkyl, NH₂, C1-C3 alkylamino, C1-C3 dialkylamino, —C(O)NH₂, —C(O)NH(C1-C3 alkyl), —C(O)(C1-C3 alkyl), —CO₂R**, —C(O)C(O)R**, —C(O)CH₃, —C(O)OH, —C(O)O—(C1-C3 alkyl), —SO₂NH₂—SO₂NH(C1-C3alkyl), —SO₂N(C1-C3alkyl)₂, NHSO₂H, NHSO₂(C1-C3 alkyl), —C(═S)NH₂, —C(═S)NH(C1-C3 alkyl), —C(═S)N(C1-C3 alkyl)₂, —C(═NH)—N(H)₂, —C(═NH)—NH(C1-C3 alkyl) and —C(═NH)—N(C1-C3 alkyl)₂,

An optionally substituted alkyl group or non-aromatic carbocyclic or heterocyclic group as defined herein may contain one or more substituents. Examples of suitable substituents for an alkyl group include those listed above for a substitutable carbon of an aryl and the following: ═O, ═S, ═NNHR**, ═NN(R**)₂, ═NNHC(O)R**, ═NNHCO₂ (alkyl), ═NNHSO₂ (alkyl), ═NR**, spiro cycloalkyl group or fused cycloalkyl group. R** in each occurrence, independently is —H or C1-C6 alkyl. Preferred substituents on alkyl groups are as defined throughout the specification. In certain embodiments optionally substituted alkyl groups are unsubstituted.

Further, examples of suitable substituents on an alkyl, aryl or acyl group may include, for example, halogen (—Br, —Cl, —I and —F), —OR^{a}, —CN, —NO₂, —N(Rₐ)₂, —COORₐ, —CON(Rₐ)₂, —SOₖRₐ (k is 0, 1 or 2) and —NH—C(═NH)—NH₂. An alkyl group can also have ═O or ═S as a substituent. Each Rₐ is independently —H, an alkyl group, a substituted alkyl group, a benzyl group, a substituted benzyl group, an aryl group or a substituted aryl group. A substituted benzylic group or aryl group can also have an alkyl or substituted alkyl group as a substituent. A substituted alkyl group can also have a benzyl, substituted benzyl, aryl or substituted aryl group as a substituent. A substituted alkyl, substituted aryl or substituted acyl group can have more than one substituent.

A “spiro cycloalkyl” group is a cycloalkyl group which shares one ring carbon atom with a carbon atom in an alkylene group or alkyl group, wherein the carbon atom being shared in the alkyl group is not a terminal carbon atom. >C— as used herein is a ring carbon atom where >represents two bonds, each to a ring carbon atom.

Without wishing to be bound by any theory or limited to any mechanism it is believed that macromolecular antioxidants and polymeric macromolecular antioxidants of the present invention exploit the differences in activities (ks, equilibrium constant) of, for example, homo- or hetero-type antioxidant moieties. Antioxidant moieties include, for example, hindered phenolic groups, unhindered phenolic groups, aminic groups and thioester groups, etc. of which there can be one or more present in each macromolecular antioxidant molecule. As used herein a homo-type antioxidant macromolecule comprises antioxidant moieties which are all same, for example, hindered phenolic, —OH groups. As used herein a hetero-type antioxidant macromolecule comprises at least one different type of moiety, for example, hindered phenolic and aminic groups in the one macromolecule.

This difference in activities can be the result of, for example, the substitutions on neighboring carbons or the local chemical or physical environment (for example, due to electrochemical or stereochemical factors) which can be due in part to the macromolecular nature of molecules.

In one embodiment of the present invention, a series of macromolecular antioxidant moieties of the present invention with different chemical structures can be represented by W1H, W2H, W3H, . . . to WnH. In one embodiment of the present invention, two types of antioxidant moieties of the present invention can be represented by: W1H and W2H. In certain embodiments W1H and W2H can have rate constants of k1 and k2 respectively. The reactions involving these moieties and peroxyl radicals can be represented as: 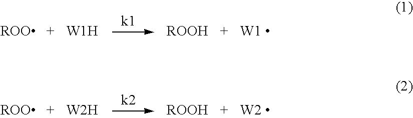
where ROO. is a peroxyl radical resulting from, for example, initiation steps involving oxidation activity, for example:
RH→R.+H. (3)
R.+O2→ROO. (4)

In one particular embodiment of the present invention k1>>k2 in equations (1) and (2). As a result, the reactions would take place in such a way that there is a decrease in concentration of W1. free radicals due their participation in the regeneration of active moiety W2H in the molecule according equation (5):
W1.+W2H→W1H+ W2. (5) (transfer equilibrium)

This transfer mechanism may take place either in intra- or inter-molecular macromolecules. The transfer mechanism (5) could take place between moieties residing on the same macromolecule (intra-type) or residing on different macromolecules (inter-type).

In certain embodiments of the present invention, the antioxidant properties described immediately above (equation 5) of the macromolecular antioxidants and polymeric macromolecular antioxidants of the present invention result in advantages including, but not limited to:
a) Consumption of free radicals W1. according to equation (5) can result in a decrease of reactions of W1. with hydroperoxides and hydrocarbons (RH).
b) The regeneration of W1H provides extended protection of materials. This is a generous benefit to sacrificial type of antioxidants that are used today. Regeneration of W1H assists in combating the oxidation process The increase in the concentration of antioxidant moieties W1H (according to equation 5) extends the shelf life of materials.

In certain embodiments of the present invention, the following items are of significant interest for enhanced antioxidant activity in the design of the macromolecular antioxidants and polymeric macromolecular antioxidants of the present invention:

a) The activity of proposed macromolecular antioxidant is dependent on the regeneration of W1H in equation (5) either through inter- or intra-molecular activities involving homo- or hetero-type antioxidant moieties.

b) Depending on the rates constants of W1H and W2H it is possible to achieve performance enhancements by many multiples and not just incremental improvements.

In certain embodiments of the present invention, more than two types of antioxidant moieties with different rate constants are used in the methods of the present invention.

The entire contents of each of the following are incorporated herein by reference.
Docket No.: 3805.1000-000; Provisional Patent Application No. 60/632,893, filed Dec. 3, 2004, Title: Process For The Synthesis Of Polyalkylphenol Antioxidants, by Suizhou Yang, et al;
Docket No.: 3805.1000-001; filed Dec. 2, 2005, Title: Process For The Synthesis Of Polyalkylphenol Antioxidants, by Suizhou Yang, et al;
Docket No.: 3805.1002-000; Provisional Patent Application No. 60/633,252, filed Dec. 3, 2004, Title: One Pot Process For Making Polymeric Antioxidants, by Vijayendra Kumar, et al.;
Docket No.: 3805.1002-001; filed Dec. 2, 2005, Title: One Pot Process For Making Polymeric Antioxidants, by Vijayendra Kumar, et al.;
Docket No.: 3805.1003-000; Provisional Patent Application No. 60/633,196, filed Dec. 3, 2004, Title: Synthesis Of Aniline And Phenol-Based Macromonomers And Corresponding Polymers, by Rajesh Kumar, et al.;
Docket No.: 3805.1003-001; filed Dec. 2, 2005, Title: Synthesis Of Aniline And Phenol-Based Macromonomers And Corresponding Polymers, by Rajesh Kumar, et al.;
Docket No.: 3805.1004-002; patent application Ser. No. 11/184,724, filed Jul. 19, 2005, Title: Anti-Oxidant Macromonomers And Polymers And Methods Of Making And Using The Same, by Ashok L. Cholli;
Docket No.: 3805.1004-005; patent application Ser. No. 11/184,716, filed Jul. 19, 2005, Title: Anti-Oxidant Macromonomers And Polymers And Methods Of Making And Using The Same, by Ashok L. Cholli;
Docket No.: 3805.1005-000; Provisional Patent Application No. 60/655,169, filed Feb. 22, 2005, Title: Nitrogen And Hindered Phenol Containing Dual Functional Macromolecules: Synthesis And Their Antioxidant Performances In Organic Materials, by Rajesh Kumar, et al.
Docket No.: 3805.1006-000; Provisional Patent Application No. 60/655,169, filed Mar. 25, 2005, Title: Alkylated Macromolecular Antioxidants And Methods Of Making, And Using The Same, by Rajesh Kumar, et al.
Docket No.: 3805.1007-000; Provisional Patent Application No. 60/731,125, filed Oct. 27, 2005, Title: Macromolecular Antioxidants And Polymeric Macromolecular Antioxidants, by Ashok L. Cholli, et al.
Docket No.: 3805.1008-000; Provisional Patent Application No. 60/731,021, filed Oct. 27, 2005, Title: Macromolecular Antioxidants Based On Sterically Hindered Phenols And Phosphites, by Ashok L. Cholli, et al.
Docket No.: 3805.1009-000; Provisional Patent Application, filed Dec. 2, 2005, Title: Lubricant Composition, by Kumar, Rajesh, et al.
Docket No.: 3805.1010-000; Provisional Patent Application No. 60/731,325, filed Oct. 27, 2005, Title: Stabilized Polyolefin Composition, by Kumar, Rajesh, et al.
Docket No.: 0813.2006-003; patent application Ser. No. 11/040,193, filed Jan. 21, 2005, Title: Post-Coupling Synthetic Approach For Polymeric Antioxidants, by Ashok L. Choll, et al.;
Docket No.: 0813.2006-002; Patent Application No.: PCT/US2005/001948, filed Jan. 21, 2005, Title: Post-Coupling Synthetic Approach For Polymeric Antioxidants, by Ashok L. Cholli et al.;
Docket No.: 0813.2002-008; Patent Application No.: PCT/US2005/001946, filed Jan. 21, 2005, Title: Polymeric Antioxidants, by Ashok L. Choll, et al.;
Docket No.: 0813.2002-006; Patent Application No.: PCT/US03/10782, filed Apr. 4, 2003, Title: Polymeric Antioxidants, by Ashok L. Choll, et al.;
Docket No.: 0813.2002-004; patent application Ser. No. 10/761,933, filed Jan. 21, 2004, Title: Polymeric Antioxidants, by Ashish Dhawan, et al.;
Docket No.: 0813.2002-001; patent application Ser. No. 10/408,679, filed Apr. 4, 2003, Title: Polymeric Antioxidants, by Ashok L. Choll, et al.;
Tertiary Butoxy Derivatives of Phenol. (Jan Pospisil and Ludek Taimr). (1964), 2 pp. CS 111291
A New Synthesis of aryl tert-butyl Ethers. Masada, Hiromitsu; Oishi,Yutaka. Fac. Eng., Kanazawa Univ., Kanazawa, Japan. Chemistry Letters (1978), (1), 57-8.
Simple Synthesis of the tert-butyl Ether of Phenol. Ol'dekop, Yu. A.; Maier, N. A.; Erdman, A. A.; Shirokii, V. L.; Zubreichuk, Z. P.; Beresnevich, L. B. Inst. Fiz.-Org. Khim., Minsk, USSR. Zhurnal Obshchei Khimii (1980), 50(2), 475-6.
New Method for the Williamson Ether Synthesis Using tert-alkyl Halides in Nonpolar Solvents. Masada, Hiromitsu; Mikuchi, Fumio; Doi, Yasuo; Hayashi, Akira. Dep. Chem. Chem. Eng., Kanazawa Univ., Kanazawa, Japan. Nippon Kagaku Kaishi (1995), (2), 164-6.
New Heterogeneous Williamson Synthesis of Ethers Using tert-alkyl Substrates. Masada, Hiromitsu; Doi, Yasuo; Mikuchi, Fumio; Keiko, Kigoshi. Faculty Eng., Kanazawa Univ., Kanazawa, Japan. Nippon Kagaku Kaishi (1996), (3), 275-82.
Preparation of Aromatic Tertiary Ethers. Tanaka, Masato; Reddy, Nagaveri Prabacal. (Agency of Industrial Sciences and Technology, Japan). Jpn. Kokai Tokkyo Koho (1999), 3 pp. JP 080063.
Preparation of Aromatic Ethers. Watanabe, Makoto; Koie, Yasuyuki. (Tosoh Corp., Japan). Jpn. Kokai Tokkyo Koho (1999), 10 pp. JP 11158103.
o-Alkylated phenols. Firth, Bruce E.; Rosen, Terry J. (UOP Inc., USA). U.S. Pat. No. 4,447,657 (1984), 4 pp.
2-Tert-Butyl-4-alkoxy- and -4-hydroxyphenols. Firth, Bruce E.; Rosen, Terry J. (UOP Inc., USA). U.S. Pat. No. 4,465,871 (1984), 4 pp.
Conversion of Alkyl Phenyl Ether to Alkylphenol. Klicker, James D. (Borg-Warner Corp., USA). U.S. Pat. No. 4,283,572 (1981), 3 pp.
O. N. Tsevktov, K. D. Kovenev, Int. J. Chem. Eng. 6 (196.6), 328.
Sartori Giovanni, Franca Bigi et al., Chem. Ind. (London), 1985 (22) 762-763.
V. A. Koshchii, Ya.B Kozlikovskii, A. A Matyusha,Zh. Org. Khim. 24(7), 1988, 1508-1512.
Gokul K. Chandra, M. M. Sharma, Catal. Lett. 19(4), 1993, 309-317.
Sakthivel, Ayyamperumal; Saritha, Nellutla; Selvam,Parasuraman, Catal. Lett. 72(3), 2001, 225-228.
V. Quaschning, J. Deutsch, P. Druska, H. J. Niclas and E. Kemnitz. J Catal. 177 (1998), p. 164.
S. K. Badamali, S. Sakthivel and P. Selvam. Catal. Today 63 (2000), p. 291.
A. Heidekum, M. A. Harnim and F. Hoelderich. J. Catal. 188 (1999), p. 230.
Y. Kamitori, M. Hojo, R. Matsuda, T. Izumi and S. Tsukamoto. J. Org Chem. 49 (1984), p. 4165.
E. Armengol, A. Corma, H. Garcia and J. Primo. Appl. Catal. A 149 (1997), p. 411.
J. M. Lalancette, M. J. Fournier and R. Thiffault. Can. J. Chem. 52 (1974), p. 589.
Japanese Patent No. JP 145002980, 1970.
Japanese Patent No. 44028850, 1969.
Japanese Patent No. 44024274, 1969.

### EXEMPLIFICATION

The formation of macromolecular antioxidant are illustrated with following examples.

### Example 1

### Preparation of Polyalkylphenol Antioxidant

Step 1: Polymerization

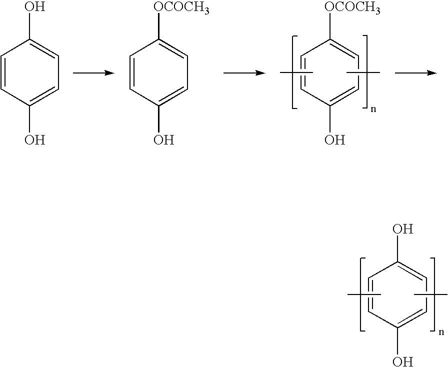

Hydroquinone (one mole) is dissolved in pyridine and acetic anhydride (0.5 mole) is added to it and the reaction mixture is stirred for 5 hrs, the reaction mixture is added in ice-cold water and extracted with ethyl acetate. Monoacetate is separated from traces of di-acetate.

Monoacetyl-hydroquinone(1 mole) is dissolved in tetrahydrofuran and Fe-Salen catalyst (0.1% by weight) added to it and the reaction mixture is stirred for 30 minutes followed by addition of hydrogen peroxide (1 mole) over period of 1 hr. The reaction mixture is stirred for 24 hrs. After completion of reaction the solvent is removed and the solid is re-dissolved in 2% HCl/methanol solution and stirred for 8 hrs for deacetylation. The de-acetylated polymer is precipitated in water from methanol solution. The powder is filtered and dried completely.

Step 2: t-Butylation of polymer

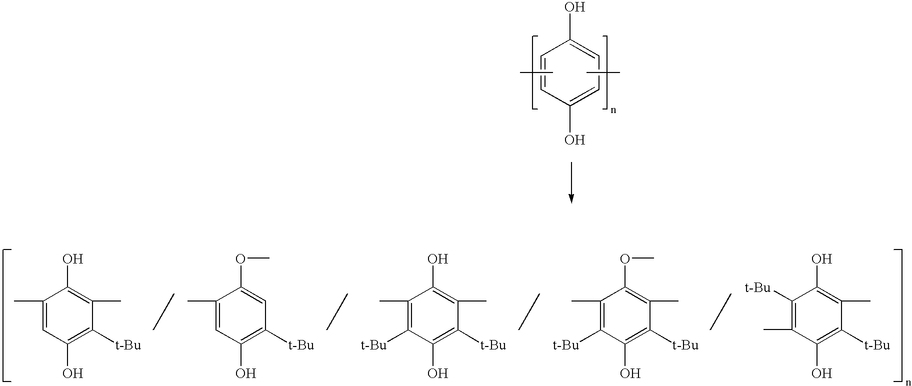

Deacetylated polymer (1 mole monomer unit), t-BuOH (1-1.5 mole) and (0.1% by weight) dodecatungstophosphoric acid are reacted at 150° C. for 8 hrs resulting in formation of mono and di-tert-butyl substituted units.

### Example 2

### Preparation of Polyalkylphenol Antioxidant

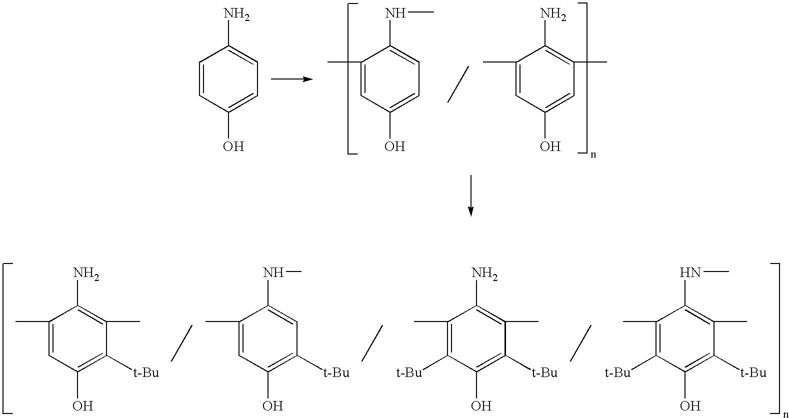 1. Polymerization

4-Amino-phenol (1 mole) is dissolved in tetrahydrofuran and Fe-Salen catalyst (0.1% by weight) added to it, the reaction mixture is stirred for 30 minutes followed by addition of hydrogen peroxide (1 mole) over a period of 1 hr. The reaction mixture is stirred for 24 hrs. After completion of the reaction the solvent is removed and the solid is dissolved in methanol solution. The polymer is precipitated in water from methanol solution. The powder is filtered and dried completely.

2. Alkyation

The polymer (1 mole monomer unit), t-BuOH (1-1.5 mole) and Clay K-10 (5% by weight) are reacted at 180° C. for 16 hrs resulting in formation of mono and di-tert-butyl substituted units.

### Example 3

### Preparation of Polyalkylphenol Antioxidant

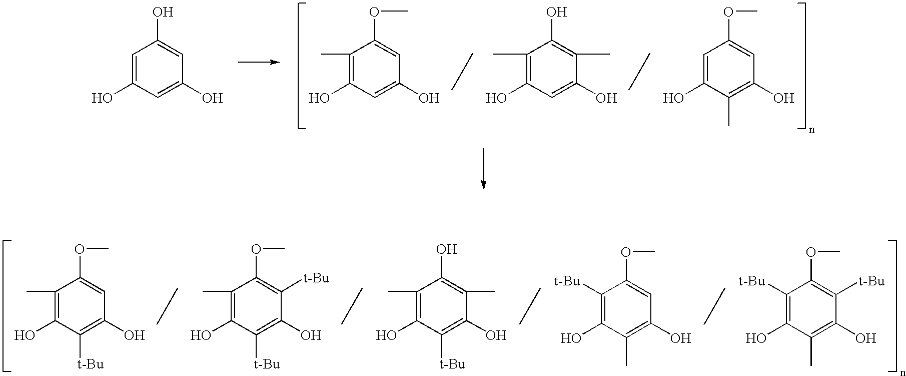 1. Polymerization

Phloroglucinol(1 mole) is dissolved in tetrahydrofuran and Fe-Salen catalyst(0.1% by weight) added to it and the reaction mixture is stirred for 30 minutes followed by addition of hydrogen peroxide (1 mole) over period of 1 hr. The reaction mixture is stirred for 24 hrs. After completion of the reaction the solvent is removed and the solid is dissolved in methanol solution. The polymer is precipitated in water from methanol solution. The powder is filtered and dried completely.

2. Alkylation

The polymer (1 mole monomer unit), t-BuOH (1-1.5 mole) and perchloric acid (0.5% by weight) are reacted at 80° C. for 16 hrs resulting in formation of mono, di, tri and tetra tert-butyl substituted units.

### Example 4

### Preparation of Polyalkylphenol Antioxidant

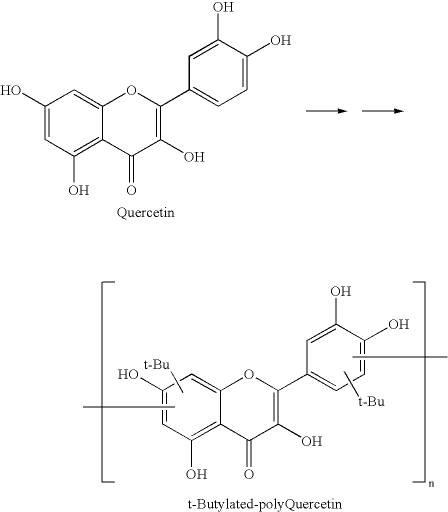 1. Polymerization

Quercetin(1 mole) is dissolved in tetrahydrofuran and Fe-Salen catalyst(0.1% by weight) added to it and the reaction mixture is stirred for 30 minutes followed by addition of hydrogen peroxide(1 mole) over period of 1 hr. The reaction mixture is stirred for 24 hrs. After completion of the reaction the solvent is removed and the solid is dissolved in methanol solution and the polymer is precipitated in water from methanol solution. The powder is filtered and dried completely.

2. Alkyation

The polymer (1 mole monomer unit), t-BuOH(1-1.5 mole) and Clay K-10 (5% by weight) are reacted at 180° C. for 16 hrs resulting in formation of mono, di, tri and tetra tert-butyl substituted units.

### Example 5

### Preparation of Polyalkylphenol Antioxidant

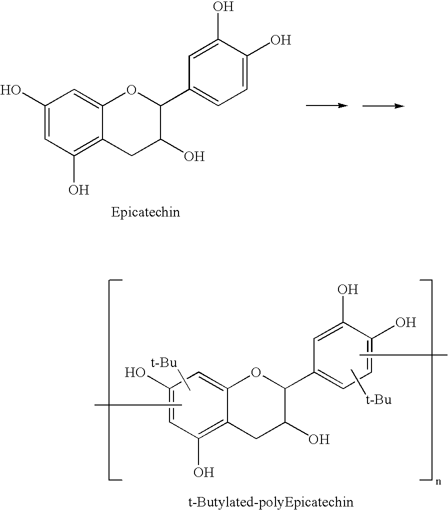 1. Polymerization

Epicatechin (1 mole) is dissolved in tetrahydrofuran and Fe-Salen catalyst(0.1% by weight) added to it and the reaction mixture is stirred for 30 minutes followed by addition of hydrogen peroxide(1 mole) over period of 1 hr. The reaction mixture is stirred for 24 hrs. After completion of reaction solvent is removed and the solid is dissolved in methanol solution the polymer is precipitated in water from methanol solution. The powder is filtered and dried completely.

2. Alkylation

The polymer (1 mole monomer unit), t-BuOH(1-1.5 mole) and Clay K-10 (5% by weight) are reacted at 180° C. for 16 hrs resulting in formation of mono, di, tri and tetra tert-butyl substituted units.

### Example 6

### Preparation of Polyalkylphenol Antioxidant

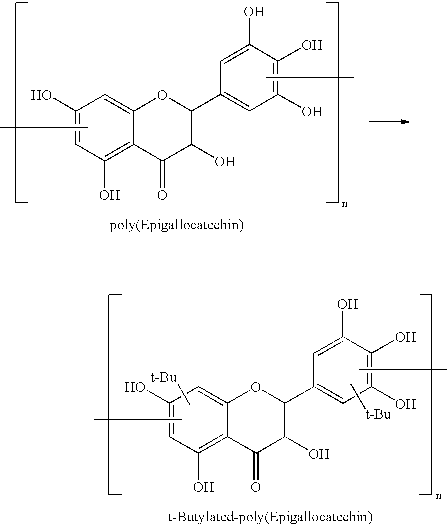 1. Polymerization

Epigallocatechin (1 mole) is dissolved in tetrahydrofuran and Fe-Salen catalyst (0.1% by weight) added to it and the reaction mixture is stirred for 30 minutes followed by addition of hydrogen peroxide(1 mole) over period of 1 hr. The reaction mixture is stirred for 24 hrs. After completion of reaction solvent is removed and the solid is dissolved in methanol solution polymer is precipitated in water from methanol solution. The powder is filtered and dried completely.

2. Alkylation

The polymer(1 mole monomer unit), t-BuOH(1-1.5 mole) and Clay K-10 (5% by weight) are reacted at 180° C. for 16 hrs resulting in formation of mono and di-tert-butyl substituted units.

### Example 7

### Preparation of Polyalkylphenol Antioxidant

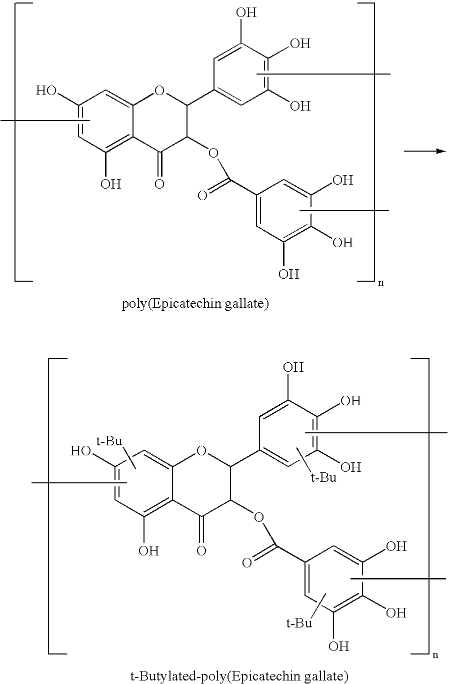 1. Polymerization

Epigallocatechin (1 mole) is dissolved in tetrahydrofuran and Fe-Salen catalyst (0.1% by weight) added to it and the reaction mixture is stirred for 30 minutes followed by addition of hydrogen peroxide(1 mole) over period of 1 hr and reaction mixture is stirred for 24 hrs. After completion of reaction solvent is removed and the solid is dissolved in methanol solution the polymer is precipitated in water from methanol solution. The powder is filtered and dried completely.

2. Alkyation

The polymer (1 mole monomer unit), t-BuOH(1-1.5 mole) and Clay K-10 (5% by weight) are reacted at 180° C. for 16 hrs resulting in formation of mono and di-tert-butyl substituted units.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of synthesizing an antioxidant polymer, comprising the steps of:
a) polymerizing a phenol containing monomer represented by the following structural formula: 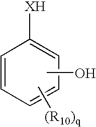
wherein:
at least one ring carbon atom substituted with an —OH group is adjacent to one unsubstituted ring carbon atom;
X is —O—, —NH— or —S—;
each R₁₀ is independently an optionally substituted C1-C10 alkyl group, an optionally substituted aryl group, and optionally substituted alkoxy group, an optionally substituted carbonyl group, an optionally substituted alkoxycarbonyl group, an optionally substituted aryloxycarbonyl group, —OH, —SH or —NH₂; or two R₁₀ groups on adjacent carbon atoms join together to form an optionally substituted aromatic ring or an optionally substituted carbocyclic or heterocyclic non-aromatic ring; and
q is an integer from 0 to 2;
to produce a polymeric macromolecule comprising at least one repeat unit selected from: 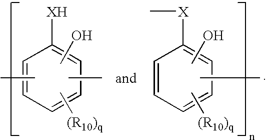
wherein:
n is an integer equal to or greater than 2; and
b) alkylating the polymeric macromolecule at a ring carbon atom adjacent to a ring carbon atom substituted with an —OH group, to produce a sterically hindered polymeric macromolecular antioxidant comprising at least one repeat unit selected from: 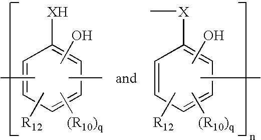
wherein:
R₁₂ is a bulky alkyl group.

2. The method of claim 1 wherein X is —O—.

3. The method of claim 2, wherein the monomer in step a) is represented by the following structural formula:

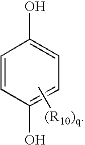

4. The method of claim 3, wherein the polymeric macromolecule is alkylated in step b) with a tert-butyl containing compound.

5. The method of claim 4, wherein the tert-butyl containing compound is selected from the group comprising t-butanol, isobutanol, isobutene, styrene, diisobutylene, 2-bromo-2-methyl-propane, benzyl chloride and t-butyl chloride.

6. The method of claim 5, wherein sterically hindered polymeric macromolecular antioxidant produced in step b) comprises at least one repeat unit selected from:

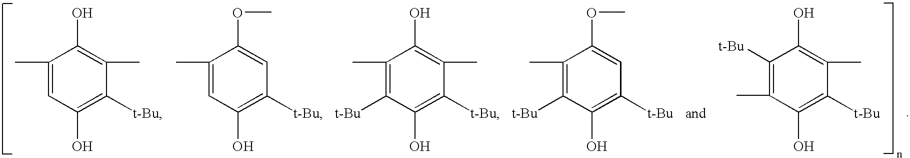

7. The method of claim 6, wherein the polymerization in step a) is carried out in the presence of a biocatalyst or a biomimetic catalyst selected from Iron(II)-salen complexes, horseradish peroxidase (HRP), soybean peroxidase (SBP), hematin, laccase, tyroniase, and a tyroniase-model complex.

8. The method of claim 7, wherein the polymerization in step a) is carried out in the presence of an inorganic or organometallic catalyst.

9. The method of claim 2, wherein the monomer in step a) is represented by the following structural formula:

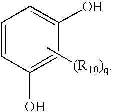

10. The method of claim 2, wherein the monomer in step a) is represented by the following structural formula:

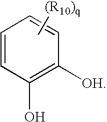

11. The method of claim 2, wherein monomer in step a) is represented by the following structural formula: 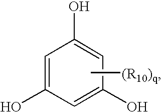
wherein:
q is 0 or 1.

12. The method of claim 11, wherein sterically hindered polymeric macromolecular antioxidant produced in step b) comprises at least one repeat unit selected from:

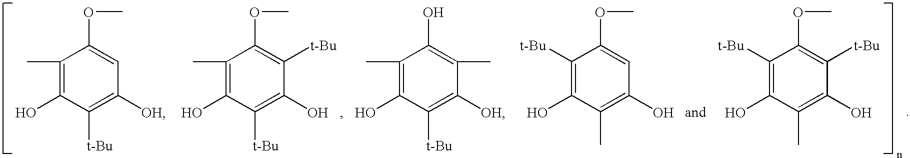

13. The method of claim 1, wherein X is —NH—.

14. The method of claim 13, wherein monomer in step a) is represented by the following structural formula:

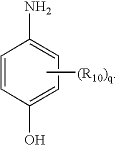

15. The method of claim 14, wherein sterically hindered polymeric macromolecular antioxidant produced in step b) comprises at least one repeat unit selected from:

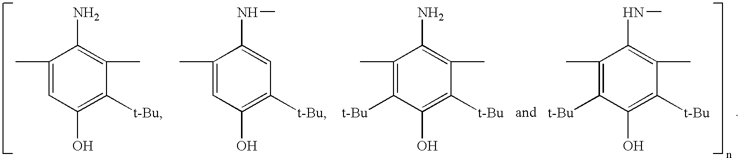

16. The method of claim 1, wherein each R₁₀ is independently C1-C10 alkyl, —OH, —SH or —NH₂, or two R₁₀ groups on adjacent carbon atoms join together to form an optionally substituted aromatic ring or an optionally substituted carbocyclic or heterocyclic non-aromatic ring.

17. The method of claim 16, wherein the monomer in step a) is represented by the following structural formula: 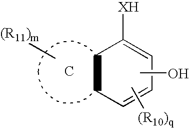
wherein:
Ring C is a five or six membered aromatic or carbocyclic or heterocyclic non-aromatic ring;
each R₁₀ is independently C1-C10 alkyl group, —OH, —SH or —NH₂;
R₁₁ is ═O, —OH, C1-C3 alkyl, optionally substituted aryl, —OC(O)(C1-C3 alkyl), —OC(O)(aryl), —OC(O)(substituted aryl), —OC(O)(aralkyl), or —OC(O)(substituted aralkyl);
q is 0 or 1; and
m is an integer from 0 to 3.

18. The method of claim 17, wherein Ring C is a non-aromatic heterocyclic ring.

19. The method of claim 18, wherein Ring C is tetrahydropyranyl or dihydropyranyl.

20. The method of claim 19, wherein the monomer in step a) is represented by the following structural formula:

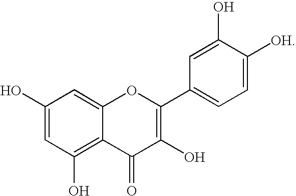

21. The method of claim 19, wherein the monomer in step a) is represented by the following structural formula:

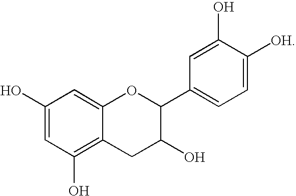

22. The method of claim 19, wherein the monomer in step a) is represented by the following structural formula:

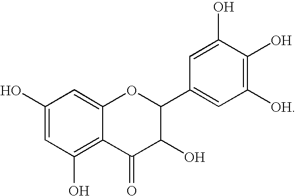

23. The method of claim 19, wherein the monomer in step a) is represented by the following structural formula: [chemical structure]
